(19) United States
(12) Patent Application Publication
(10) Pub. No.: US 2018/0137541 A1
(43) Pub. Date: May 17, 2018

(54) METHODS AND SYSTEMS FOR DETERMINING DUPLICATION IN IMPRESSIONS DATA

(71) Applicant: Rovi Guides, Inc., San Carlos, CA (US)

(72) Inventors: Alexis Yelton, Somerville, MA (US); Steven Bennett, Somerville, MA (US); Abhijeet Sharma, Boston, MA (US)

(21) Appl. No.: 15/353,877

(22) Filed: Nov. 17, 2016

(51) Int. Cl. G06Q 30/02

(52) U.S. Cl. CPC G06Q 30/0272; G06Q 30/0277

(57) ABSTRACT

Methods and systems for determining advertisement placements are described herein. The method includes retrieving a matrix of access time values, wherein each row is associated with a respective user, each column is associated with a respective media asset, and each access time value represents a length of time for which a respective user accessed a respective media source. The method includes identifying media sources accessed by a user, creating combinations of the identified media sources, and determining a minimum access value associated with each combination of the identified media sources. The method further includes creating an overlap value by adding the determined minimum access values to create an overlap value associated with each combination and selecting, based on the overlap value, a subset of a plurality of advertisement placement spots.

### BACKGROUND

Reach values are a metric used to describe how many unique people an advertisement or a media asset reached. Impression values are a metric used to describe how many non-unique views an advertisement or media asset received. Reach values are often important in determining where advertisements should be placed to have the maximum impact by reaching the largest possible audience. Traditional reach optimization systems use impression values as a proxy for reach. Often, impression values include duplicate values because the same user may view an advertisement or media asset multiple times, thus contributing to the impression values multiple times. Using impression values as a proxy for reach without accounting for duplication may result in inaccurate reach values being determined.

### SUMMARY

Methods and systems for determining advertisement placements are described in this disclosure. In some aspects, the method includes receiving, from a database of viewing data, a matrix of access time values, wherein each row of the matrix is associated with a respective user and each column of the matrix is associated with a respective media source, and wherein each access time value in the matrix represents a length of time for which a respective user accessed a respective media source. For example, the optimization system may receive the following matrix, where the rows are associated with users A, B, and C respectively, and the columns are associated with media sources A, B, and C respectively.

$$[ \begin{matrix}10 & 20 & 5 \\ 10 & 15 & 30 \\ 20 & 5 & 20\end{matrix} ]$$

The method may include identifying, using the matrix, a plurality of media sources accessed by the user. For example, using the matrix above, the optimization system may determine that user A accessed media sources A, B, and C for 10, 20, and 5 seconds respectively. The method may include creating a plurality of pairs by determining combinations of media sources from the plurality of media sources accessed by the user. For example, the optimization system may create the following pairs using media sources A, B, and C: [A, B], [B, C], and [C, A].

The method may include determining, for each pair comprising a first media source and a second media source in the plurality of pairs of media sources, a minimum access value from a first access time value associated with the first media source and the user and a second access time value associated with the second media source and the user. For example, if user A accessed media source A for 10 seconds and media source B for 20 seconds, the optimization system may determine a minimum access value for this pair of media sources of 10 seconds. Similarly, the minimum access values for the pairs media sources B and C and media sources C and A may be 5 seconds and 5 seconds respectively.

The method may include creating an overlap value associated with each pair of media sources by adding, for each user who accessed the pair of media sources, the respective minimum access value associated with the pair of media sources. For example, if user A is associated with minimum access value for media sources A and B of 10 seconds and user B is associated with minimum access value for media sources A and B of 5 seconds, the optimization system may create an overlap value of 10+5=15 seconds. The method may include selecting, using advertisement placement circuitry and the overlap value, a subset of a plurality of advertisement placement spots. For example, the advertisement placement circuitry may take into account the overlap value to compute reach proxy values, and then use the reach values to select advertisement placement spots that provide a large reach value.

In some embodiments, the method may include creating a plurality of overlap values, wherein each overlap value of the plurality of overlap values is associated with a respective pair of media sources, and the plurality of overlap values comprises the first overlap value, and selecting a representative overlap value of the plurality of overlap values. In some embodiments, selecting the representative overlap value further comprises selecting a mean value, a median value, or a mode value of the plurality of overlap values. For example, the optimization system may create overlap values of 20, 50, and 40 seconds corresponding to each of three different pairs of media sources. The optimization system may select 40 seconds as the median representative value or 36 seconds as the mean representative value.

In some embodiments, the method may include receiving a selection of a demographic category, wherein each row of the matrix is associated with a respective user associated with the demographic category. For example, the optimization system may receive a selection of the demographic category “ages 18-40”, wherein users A, B, and C in the matrix are associated with the demographic categories “age 21-25,” “age 60+,” and “age 18-40” respectively. The optimization circuitry may compute overlap values only using the selected users. In some embodiments, the method may include computing overlap values for multiple pairs of media sources in parallel. In some embodiments, the method may include computing a performance indicator for the subset of the plurality of advertisement placement spots. For example, the optimization circuitry may compute a target rating point or a gross rating point measurement for the selected subset of advertisement placement spots.

The method may include using the advertisement placement circuitry by performing non-linear optimization of reach. The method may include computing probabilities that a user will access each of a plurality of media sources. The method includes computing, using the probabilities, reach values associated with each combination of the plurality of advertisement placement spots. The method may include identifying the subset of the plurality of advertisement placement spots that maximize a reach value. Computing the reach values may further comprise computing a probability associated with each of the plurality of advertisement placement spots and computing the reach value based on the plurality of probabilities and a weight associated with the user.

In some embodiments, the method may include receiving, from the database of viewing data, a plurality of rating values or size values. The method may include scaling a portion of the matrix based on the plurality of rating values or size values by multiplying each access time value in the portion of the matrix by a respective rating value or size value. For example, the optimization system may receive the rating values 4/5, 5/5, and 3/5 associated with media sources A, B, and C respectively. The access time values associated with user A and media sources A, B, and C respectively may be 10, 20, and 5 seconds. The optimization system may scale these values by multiplying them by the ratings to result in scaled values of 8, 20, and 3 seconds.

### BRIEF DESCRIPTION OF THE FIGURES

The above and other objects and advantages of the disclosure will be apparent upon consideration of the following detailed description, taken in conjunction with the accompanying drawings, in which like reference characters refer to like parts throughout, and in which:

FIG. 1 shows an illustrative reach graph, in accordance with some embodiments of this disclosure;

FIG. 2 shows an illustrative example of a display screen generated by a media guidance application, in accordance with some embodiments of the disclosure;

FIG. 3 shows another illustrative example of a display screen generated by a media guidance application, in accordance with some embodiments of the disclosure;

FIG. 4 is a block diagram of an illustrative user equipment device, in accordance with some embodiments of the disclosure;

FIG. 5 is a block diagram of an illustrative media system, in accordance with some embodiments of the disclosure;

FIG. 6 shows an exemplary process for retrieving, from a media content database, a plurality of available spots, in accordance with some embodiments of the disclosure;

FIG. 7 shows an exemplary process for computing a plurality of probabilities associated with a user, in accordance with some embodiments of the disclosure;

FIG. 8 shows an illustrative process for computing a weight associated with a user, in accordance with some embodiments of the disclosure;

FIG. 9 shows an illustrative process for computing reach values using probability values and weight values, in accordance with some embodiments of the disclosure;

FIG. 10 shows an exemplary output screen for displaying results of the optimization system to a user of the optimization system, in accordance with some embodiments of the disclosure;

FIG. 11 shows an exemplary process for performing non-linear reach optimization, in accordance with some embodiments of the disclosure;

FIG. 12 shows an illustrative reach and impressions graph, in accordance with some embodiments of this disclosure;

FIG. 13 shows an exemplary matrix for storing access time values associated with multiple users and multiple media sources, in accordance with some embodiments of this disclosure;

FIG. 14 shows an illustrative process for identifying access time values associated with a user, in accordance with some embodiments of the present disclosure;

FIG. 16 shows an illustrative process for creating an overlap value associated with a pair of media sources, in accordance with some embodiments of the present disclosure; and

FIG. 17 shows an illustrative process for identifying a representative overlap value, in accordance with some embodiments of the present disclosure; and

FIG. 18 shows an illustrative process for determining advertisement placements, in accordance with some embodiments of the present disclosure.

### DETAILED DESCRIPTION

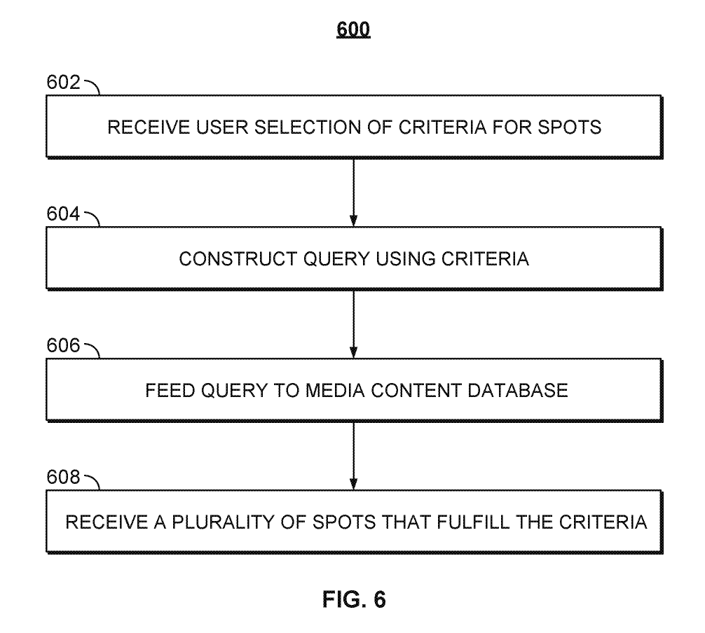

Advertisement placement circuitry, such as the circuitry in the system described in relation to FIGS. 6-11, uses historical user data to create an advertisement campaign that maximizes the reach of the advertisement campaign. However, historical data collected about user viewing history may include duplication across different media sources. For example, the same user may view 30 minutes of the television channel ABC and 30 minutes of the television channel NBC. If an advertisement campaign purchases spots on both channels, the same user will be targeted twice, and the overall reach of the campaign will not increase. Thus, it is important to account for duplication when creating advertisement campaigns. The optimization system described herein determines duplication in historical data about users' viewing habits. The effects of the duplication are then removed from the historical data, resulting in more accurate historical data. This historical data can be used as a more accurate proxy for reach values, and can be input into the advertisement placement circuitry to create better advertisement campaigns.

In some embodiments, the optimization system discussed herein removes duplication from user viewing data to allow the user viewing data to function as a proxy for reach. In some embodiments, the advertisement placement circuitry discussed herein computes reach values using the user viewing data, and creates advertisement campaigns based on the computed reach. In some embodiments, the advertisement placement circuitry and the optimization system may be integrated into the same system or be implemented using the same control circuitry 404.

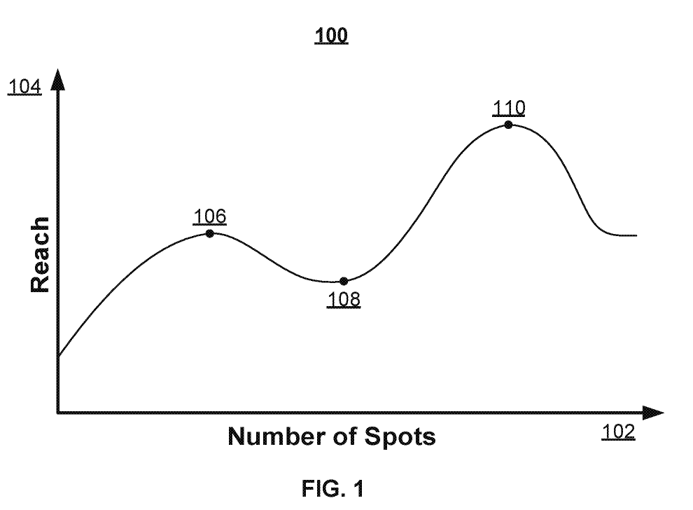

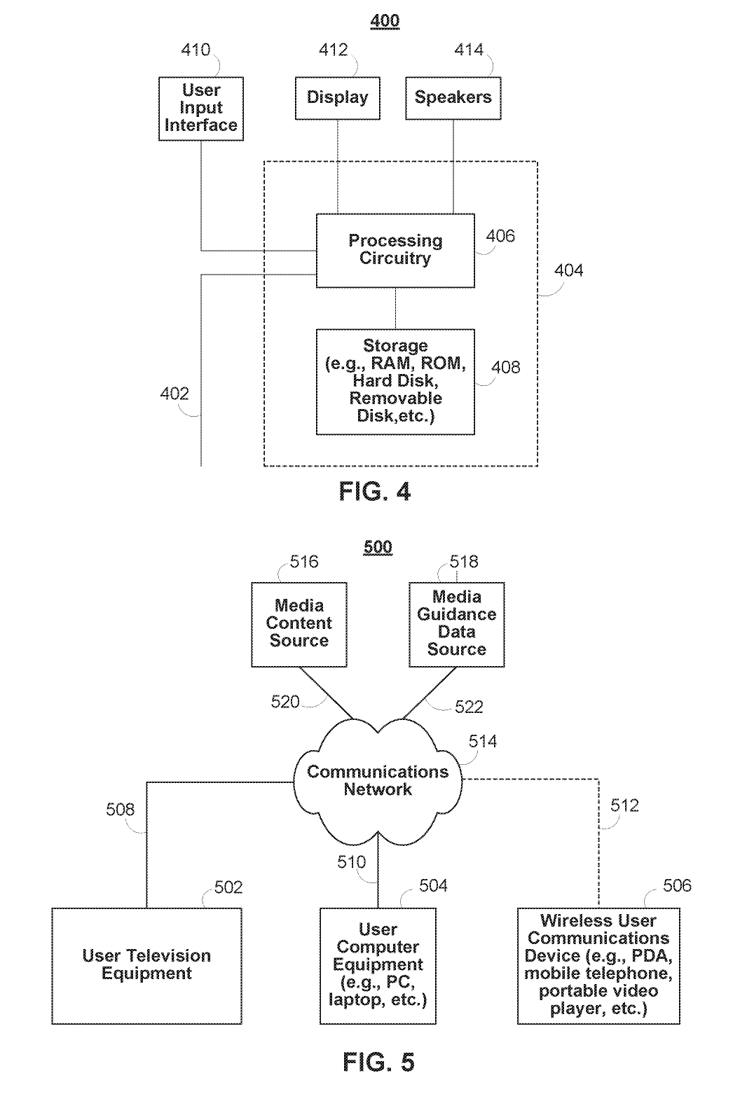

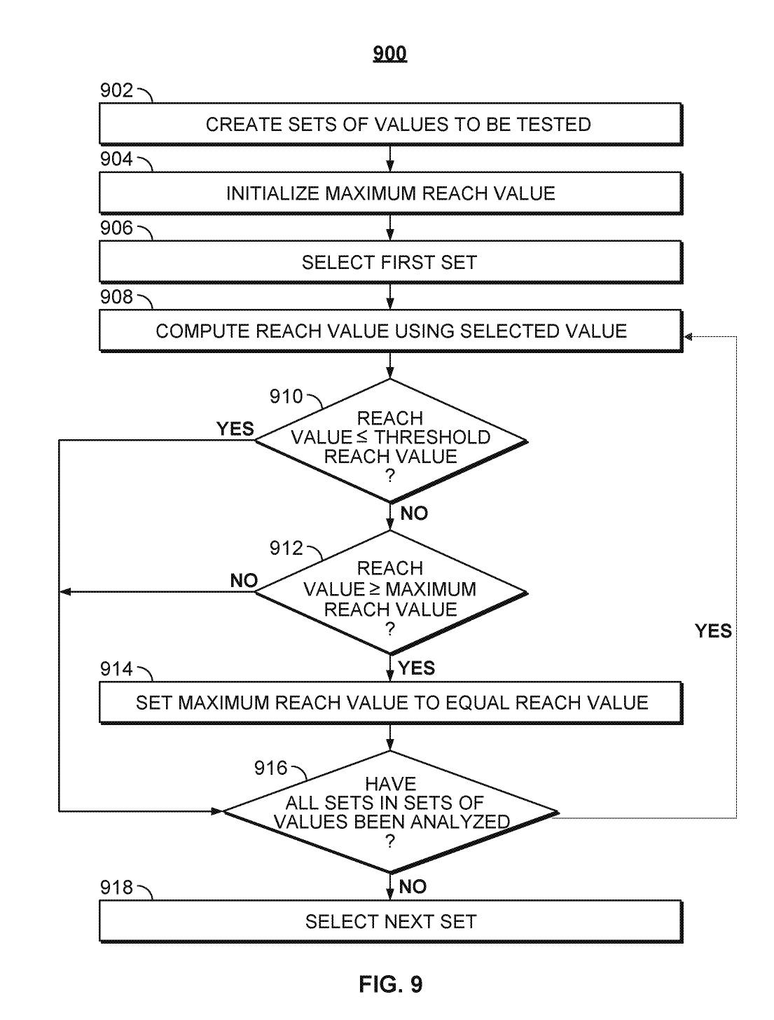

FIG. 1 shows an illustrative reach graph 100, incorporating embodiments of the present disclosure. Reach graph 100 is exemplary, and reach graphs can show any relationship between the number of spots and reach. For example, quadratic, cubic, hyperbolic, or parabolic relationships could be shown by reach graph 100. An advertisement placement circuitry may create several reach graphs using control circuitry 404 and store several reach graphs using storage circuitry 408. Control circuitry 404 and storage circuitry 408 are described below in relation to FIG. 4. The advertisement placement circuitry may create the reach graphs by using process 900 as described in relation to FIG. 9. All reach values determined in process 900 may be stored and plotted using reach graph 100. Each different reach graph may correspond to a different media source, user demographic, time, type of user device, and so on.

Axis 102 on reach graph 100 indicates a number of spots. Each spot is a point in time and space where an advertisement may be placed. An advertisement may be placed in a spot. For example, a spot may be thirty seconds long and shown on a television screen. Spots may be measured in any unit of time, such as seconds, minutes, and hours. Spots may be placed in any location as such television screens or newspapers. In some embodiments, each spot may represent a physical space. For example, each spot may represent any of billboards, newspaper advertisement spaces, and cell phone advertisement banner locations. In some embodiments, axis 102 may represent different combinations of spots. For example, a first combination of “Show A” and “Show B” and a second combination of “Show C” and “Show D” may both be included on axis 102 even though both combinations have the same number of spots.

Axis 104 on reach graph 100 indicates a reach value. As referred to herein, the reach value represents a fraction of a population that has viewed, heard, or otherwise been exposed to a spot. In some embodiments, the reach value may be a “reach n-plus” value and represent a fraction of a population that has been exposed to a spot “n” times. Reach values measure the unique users who have been exposed to a spot. For example, an audience member who has been exposed to a spot five times will cause the same shift in a reach value as an audience member who has been exposed to the spot only once. In some embodiments, axis 104 may represent the reach in a certain population and not the reach in the general population. For example, axis 104 may represent the reach among males earning less $40,000 per year.

The value of reach graph 100 for different values of axis 102 (number of spots) and axis 104 (reach) represents the number of unique people that will be reached by the given number and/or combination of spots. Point 106 on reach graph 100 shows a local maximum value of reach graph 100. Point 108 shows a local minimum value. Point 110 shows a global maximum value. A user may be interested in determining the global maximum value of reach to help the user choose which spots to place advertisements in. The user may decide not to buy more spots than the number of spots associated with point 110, since the additional spots will not increase reach. The user may also decide to place advertisements in spots associated with point 110 to achieve the largest reach possible.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

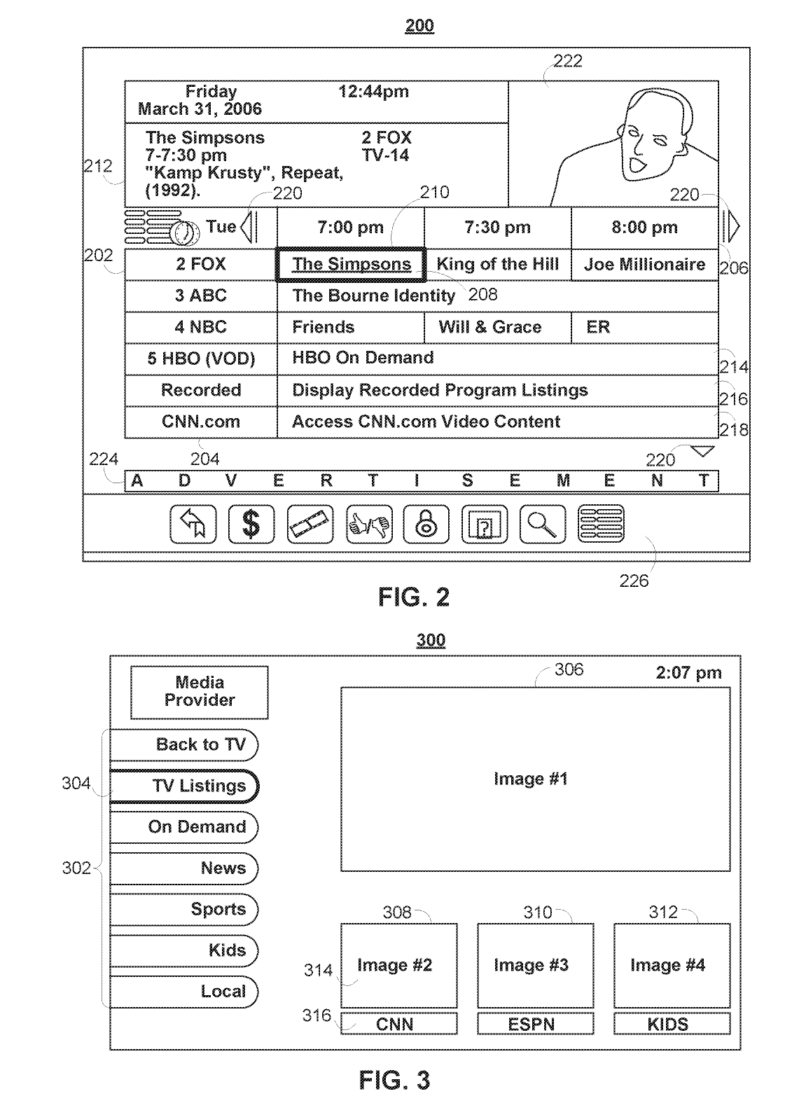

FIGS. 2-3 show illustrative display screens that may be used to provide media guidance data. The display screens shown in FIGS. 2-3 may include several advertisement spots with varying reach values. The advertisement placement circuitry may compute the reach associated with these various advertisement spots. The display screens shown in FIGS. 2-3 may be implemented on any suitable user equipment device or platform. While the displays of FIGS. 2-3 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 2 shows illustrative grid of a program listings display 200 arranged by time and channel that also enables access to different types of content in a single display. Display 200 may include grid 202 with: (1) a column of channel/content type identifiers 204, where each channel/content type identifier (which is a cell in the column) identifies a different channel or content type available; and (2) a row of time identifiers 206, where each time identifier (which is a cell in the row) identifies a time block of programming. Grid 202 also includes cells of program listings, such as program listing 208, where each listing provides the title of the program provided on the listing's associated channel and time. With a user input device, a user can select program listings by moving highlight region 210. Information relating to the program listing selected by highlight region 210 may be provided in program information region 212. Region 212 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 202 may provide media guidance data for non-linear programming including on-demand listing 214, recorded content listing 216, and Internet content listing 218. A display combining media guidance data for content from different types of content sources is sometimes referred to as a “mixed-media” display. Various permutations of the types of media guidance data that may be displayed that are different than display 200 may be based on user selection or guidance application definition (e.g., a display of only recorded and broadcast listings, only on-demand and broadcast listings, etc.). As illustrated, listings 214, 216, and 218 are shown as spanning the entire time block displayed in grid 202 to indicate that selection of these listings may provide access to a display dedicated to on-demand listings, recorded listings, or Internet listings, respectively. In some embodiments, listings for these content types may be included directly in grid 202. Additional media guidance data may be displayed in response to the user selecting one of the navigational icons 220. (Pressing an arrow key on a user input device may affect the display in a similar manner as selecting navigational icons 220.)

Display 200 may also include video region 222, advertisement 224, and options region 226. Video region 222 may allow the user to view and/or preview programs that are currently available, will be available, or were available to the user. The content of video region 222 may correspond to, or be independent from, one of the listings displayed in grid 202. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 224 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 202. Advertisement 224 may also be for products or services related or unrelated to the content displayed in grid 202. Advertisement 224 may be selectable and provide further information about content, provide information about a product or a service, enable purchasing of content, a product, or a service, provide content relating to the advertisement, etc. Advertisement 224 may be targeted based on a user's profile/preferences, monitored user activity, the type of display provided, or on other suitable targeted advertisement bases.

Advertisement 224 may be placed by a user of the advertisement placement circuitry using the information provided by the advertisement placement circuitry. The advertisement placement circuitry may use advertisement 224 as a spot and analyze the reach associated with this spot.

While advertisement 224 is shown as rectangular or banner shaped, advertisements may be provided in any suitable size, shape, and location in a guidance application display. For example, advertisement 224 may be provided as a rectangular shape that is horizontally adjacent to grid 202. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 226 may allow the user to access different types of content, media guidance application displays, and/or media guidance application features. Options region 226 may be part of display 200 (and other display screens described herein), or may be invoked by a user by selecting an on-screen option or pressing a dedicated or assignable button on a user input device. The selectable options within options region 226 may concern features related to program listings in grid 202 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 5. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 3. Video mosaic display 300 includes selectable options 302 for content information organized based on content type, genre, and/or other organization criteria. In display 300, television listings option 304 is selected, thus providing listings 306, 308, 310, and 312 as broadcast program listings. In display 300 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 308 may include more than one portion, including media portion 314 and text portion 316. Media portion 314 and/or text portion 316 may be selectable to view content in full-screen or to view information related to the content displayed in media portion 314 (e.g., to view listings for the channel that the video is displayed on).

The listings in display 300 are of different sizes (i.e., listing 306 is larger than listings 308, 310, and 312), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

Users may access content and the media guidance application (and its display screens described above and below) from one or more of their user equipment devices. The optimization system and/or advertisement placement circuitry may also be executed on a user equipment device. In some embodiments, the optimization system and/or advertisement placement circuitry may be executed in a distributed manner on many user equipment devices. FIG. 4 shows a generalized embodiment of illustrative user equipment device 400. More specific implementations of user equipment devices are discussed below in connection with FIG. 5. User equipment device 400 may receive content and data via input/output (hereinafter “I/O”) path 402. I/O path 402 may provide content (e.g., broadcast programming, on-demand programming, Internet content, content available over a local area network (LAN) or wide area network (WAN), and/or other content) and data to control circuitry 404, which includes processing circuitry 406 and storage 408. Control circuitry 404 may be used to send and receive commands, requests, and other suitable data using I/O path 402. I/O path 402 may connect control circuitry 404 (and specifically processing circuitry 406) to one or more communications paths (described below). I/O functions may be provided by one or more of these communications paths, but are shown as a single path in FIG. 4 to avoid overcomplicating the drawing.

Control circuitry 404 may be based on any suitable processing circuitry such as processing circuitry 406. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 404 executes instructions for a media guidance application stored in memory (i.e., storage 408). Specifically, control circuitry 404 may be instructed by the media guidance application to perform the functions discussed above and below. For example, the media guidance application may provide instructions to control circuitry 404 to generate the media guidance displays. In some implementations, any action performed by control circuitry 404 may be based on instructions received from the media guidance application.

In client-server based embodiments, control circuitry 404 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 5). In addition, communications circuitry may include circuitry that enables peer-to-peer communication of user equipment devices, or communication of user equipment devices in locations remote from each other (described in more detail below).

Memory may be an electronic storage device provided as storage 408 that is part of control circuitry 404. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 408 may be used to store various types of content described herein as well as media guidance data described above. Nonvolatile memory may also be used (e.g., to launch a boot-up routine and other instructions). Cloud-based storage, described in relation to FIG. 5, may be used to supplement storage 408 or instead of storage 408.

Control circuitry 404 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 404 may also include scaler circuitry for upconverting and downconverting content into the preferred output format of the user equipment 400. Circuitry 404 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 408 is provided as a separate device from user equipment 400, the tuning and encoding circuitry (including multiple tuners) may be associated with storage 408.

A user may send instructions to control circuitry 404 using user input interface 410. User input interface 410 may be any suitable user interface, such as a remote control, mouse, trackball, keypad, keyboard, touch screen, touchpad, stylus input, joystick, voice recognition interface, or other user input interfaces. Display 412 may be provided as a stand-alone device or integrated with other elements of user equipment device 400. For example, display 412 may be a touchscreen or touch-sensitive display. In such circumstances, user input interface 410 may be integrated with or combined with display 412. Display 412 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 412 may be HDTV-capable. In some embodiments, display 412 may be a 3D display, and the interactive media guidance application and any suitable content may be displayed in 3D. A video card or graphics card may generate the output to the display 412. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 404. The video card may be integrated with the control circuitry 404. Speakers 414 may be provided as integrated with other elements of user equipment device 400 or may be stand-alone units. The audio component of videos and other content displayed on display 412 may be played through speakers 414. In some embodiments, the audio may be distributed to a receiver (not shown), which processes and outputs the audio via speakers 414.

The guidance application may be implemented using any suitable architecture. For example, it may be a stand-alone application wholly-implemented on user equipment device 400. In such an approach, instructions of the application are stored locally (e.g., in storage 408), and data for use by the application is downloaded on a periodic basis (e.g., from an out-of-band feed, from an Internet resource, or using another suitable approach). Control circuitry 404 may retrieve instructions of the application from storage 408 and process the instructions to generate any of the displays discussed herein. Based on the processed instructions, control circuitry 404 may determine what action to perform when input is received from input interface 410. For example, movement of a cursor on a display up/down may be indicated by the processed instructions when input interface 410 indicates that an up/down button was selected.

In some embodiments, the media guidance application is a client-server based application. Data for use by a thick or thin client implemented on user equipment device 400 is retrieved on-demand by issuing requests to a server remote to the user equipment device 400. In one example of a client-server based guidance application, control circuitry 404 runs a web browser that interprets web pages provided by a remote server. For example, the remote server may store the instructions for the application in a storage device. The remote server may process the stored instructions using circuitry (e.g., control circuitry 404) and generate the displays discussed above and below. The client device may receive the displays generated by the remote server and may display the content of the displays locally on equipment device 400. This way, the processing of the instructions is performed remotely by the server while the resulting displays are provided locally on equipment device 400. Equipment device 400 may receive inputs from the user via input interface 410 and transmit those inputs to the remote server for processing and generating the corresponding displays. For example, equipment device 400 may transmit a communication to the remote server indicating that an up/down button was selected via input interface 410. The remote server may process instructions in accordance with that input and generate a display of the application corresponding to the input (e.g., a display that moves a cursor up/down). The generated display is then transmitted to equipment device 400 for presentation to the user.

In some embodiments, the media guidance application is downloaded and interpreted or otherwise run by an interpreter or virtual machine (run by control circuitry 404). In some embodiments, the guidance application may be encoded in the ETV Binary Interchange Format (EBIF), received by control circuitry 404 as part of a suitable feed, and interpreted by a user agent running on control circuitry 404. For example, the guidance application may be an EBIF application. In some embodiments, the guidance application may be defined by a series of JAVA-based files that are received and run by a local virtual machine or other suitable middleware executed by control circuitry 404. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 400 of FIG. 4 can be implemented in system 500 of FIG. 5 as user television equipment 502, user computer equipment 504, wireless user communications device 506, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 4 may not be classified solely as user television equipment 502, user computer equipment 504, or a wireless user communications device 506. For example, user television equipment 502 may, like some user computer equipment 504, be Internet-enabled allowing for access to Internet content, while user computer equipment 504 may, like some user television equipment 502, include a tuner allowing for access to television programming. The media guidance application may have the same layout on various different types of user equipment or may be tailored to the display capabilities of the user equipment. For example, on user computer equipment 504, the guidance application may be provided as a web site accessed by a web browser. In another example, the guidance application may be scaled down for wireless user communications devices 506.

In system 500, there is typically more than one of each type of user equipment device but only one of each is shown in FIG. 5 to avoid overcomplicating the drawing. In addition, each user may utilize more than one type of user equipment device and also more than one of each type of user equipment device.

In some embodiments, a user equipment device (e.g., user television equipment 502, user computer equipment 504, wireless user communications device 506) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 514. Namely, user television equipment 502, user computer equipment 504, and wireless user communications device 506 are coupled to communications network 514 via communications paths 508, 510, and 512, respectively. Communications network 514 may be one or more networks including the Internet, a mobile phone network, mobile voice or data network (e.g., a 4G or LTE network), cable network, public switched telephone network, or other types of communications network or combinations of communications networks. Paths 508, 510, and 512 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 512 is drawn with dotted lines to indicate that in the exemplary embodiment shown in FIG. 5 it is a wireless path and paths 508 and 510 are drawn as solid lines to indicate they are wired paths (although these paths may be wireless paths, if desired). Communications with the user equipment devices may be provided by one or more of these communications paths, but are shown as a single path in FIG. 5 to avoid overcomplicating the drawing.

Although communications paths are not drawn between user equipment devices, these devices may communicate directly with each other via communication paths, such as those described above in connection with paths 508, 510, and 512, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 514.

System 500 includes content source 516 and media guidance data source 518 coupled to communications network 514 via communication paths 520 and 522, respectively. Paths 520 and 522 may include any of the communication paths described above in connection with paths 508, 510, and 512. Communications with the content source 516 and media guidance data source 518 may be exchanged over one or more communications paths, but are shown as a single path in FIG. 5 to avoid overcomplicating the drawing. In addition, there may be more than one of each of content source 516 and media guidance data source 518, but only one of each is shown in FIG. 5 to avoid overcomplicating the drawing. (The different types of each of these sources are discussed below.) If desired, content source 516 and media guidance data source 518 may be integrated as one source device. Although communications between sources 516 and 518 with user equipment devices 502, 504, and 506 are shown as through communications network 514, in some embodiments, sources 516 and 518 may communicate directly with user equipment devices 502, 504, and 506 via communication paths (not shown) such as those described above in connection with paths 508, 510, and 512.

Content source 516 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 516 may be the originator of content (e.g., a television broadcaster, a Webcast provider, etc.) or may not be the originator of content (e.g., an on-demand content provider, an Internet provider of content of broadcast programs for downloading, etc.). Content source 516 may include cable sources, satellite providers, on-demand providers, Internet providers, over-the-top content providers, or other providers of content. Content source 516 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 518 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 518 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 518 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 518 may provide user equipment devices 502, 504, and 506 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 408, and executed by control circuitry 404 of a user equipment device 400. In some embodiments, media guidance applications may be client-server applications where only a client application resides on the user equipment device, and server application resides on a remote server. For example, media guidance applications may be implemented partially as a client application on control circuitry 404 of user equipment device 400 and partially on a remote server as a server application (e.g., media guidance data source 518) running on control circuitry of the remote server. When executed by control circuitry of the remote server (such as media guidance data source 518), the media guidance application may instruct the control circuitry to generate the guidance application displays and transmit the generated displays to the user equipment devices. The server application may instruct the control circuitry of the media guidance data source 518 to transmit data for storage on the user equipment. The client application may instruct control circuitry of the receiving user equipment to generate the guidance application displays.

Content and/or media guidance data delivered to user equipment devices 502, 504, and 506 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 500 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 5.

In one approach, user equipment devices may communicate with each other within a home network. User equipment devices can communicate with each other directly via short-range point-to-point communication schemes described above, via indirect paths through a hub or other similar device provided on a home network, or via communications network 514. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 516 to access content. Specifically, within a home, users of user television equipment 502 and user computer equipment 504 may access the media guidance application to navigate among and locate desirable content. Users may also access the media guidance application outside of the home using wireless user communications devices 506 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 514. These cloud resources may include one or more content sources 516 and one or more media guidance data sources 518. In addition or in the alternative, the remote computing sites may include other user equipment devices, such as user television equipment 502, user computer equipment 504, and wireless user communications device 506. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 504 or wireless user communications device 506 having content capture feature. Alternatively, the user can first transfer the content to a user equipment device, such as user computer equipment 504. The user equipment device storing the content uploads the content to the cloud using a data transmission service on communications network 514. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 4.

As referred herein, the term “in response to” refers to initiated as a result of. For example, a first action being performed in response to a second action may include interstitial steps between the first action and the second action. As referred herein, the term “directly in response to” refers to caused by. For example, a first action being performed directly in response to a second action may not include interstitial steps between the first action and the second action.

FIG. 6 shows an exemplary process 600 for retrieving, from a media content database, a plurality of available spots, incorporating embodiments of the present disclosure. Process 600 may be executed by control circuitry 404. The advertisement placement circuitry may execute process 600 to receive user criteria about which spots the user is interested in, and identify available spots that satisfy the user's criteria.

Process 600 begins at block 602, when control circuitry 404 receives a user selection of criteria for spots. The advertisement placement circuitry may receive the user selection through user input interface 410. In some embodiments, the user criteria may indicate which television advertisements spots should be targeted by specifying any combination of a certain channel/network, broadcast time, viewing time, targeted demographic, viewership size, parental control rating, and the like. In some embodiments, the user criteria may indicate which print advertisement spots should be targeted by specifying any combination of frequency of publication, genre, readership size, readership demographics, and the like.

Process 600 proceeds to block 604, when control circuitry 404 constructs a query using the received criteria. The advertisement placement circuitry may construct the query using any suitable language or syntax, such as XML. For example, the advertisement placement circuitry may have received user criteria stating that the user wishes to place advertisements in primetime slots aimed at women of ages 21-34. The advertisement placement circuitry may use this information to construct the following query: [“TIME=2000 TO 2300” && “GENDER=FEMALE” && “AGE=21 TO 34”].

Process 600 proceeds to block 606, when control circuitry 404 feeds the query to a media content database. The advertisement placement circuitry may use the query constructed in block 604, and transmit the query using communications network 514 to media content source 516 or media guidance data source 518. In some embodiments, if the media content database or a portion of it is locally stored or cached, the advertisement placement circuitry may also feed the query to local storage circuitry 408. The media content database may include a listing of all available advertisement slots and all unavailable advertisement slots. The advertisement placement circuitry may allow a user to place advertisements on available advertisement slots, but only join a waiting list for unavailable advertisement slots. Some or all users on the waiting list may be notified if an unavailable advertisement slot becomes available.

Process 600 proceeds to block 608, when control circuitry 404 receives a plurality of spots that fulfill the criteria. The advertisement placement circuitry may receive the spots from a remote server using communications network 514 or from local storage circuitry 408. For example, if the advertisement placement circuitry sent the query [“TIME=2000 TO 2300” && “GENDER=FEMALE” && “AGE=21 TO 34”] to a remote server, it may receive the following plurality of spots that fulfill the criteria: {(Channel 8, 2015), (Channel 8, 2016), (Channel 10, 2214), (Channel 11, 2215)}. The advertisement placement circuitry may receive any number of slots that fulfill the criteria.

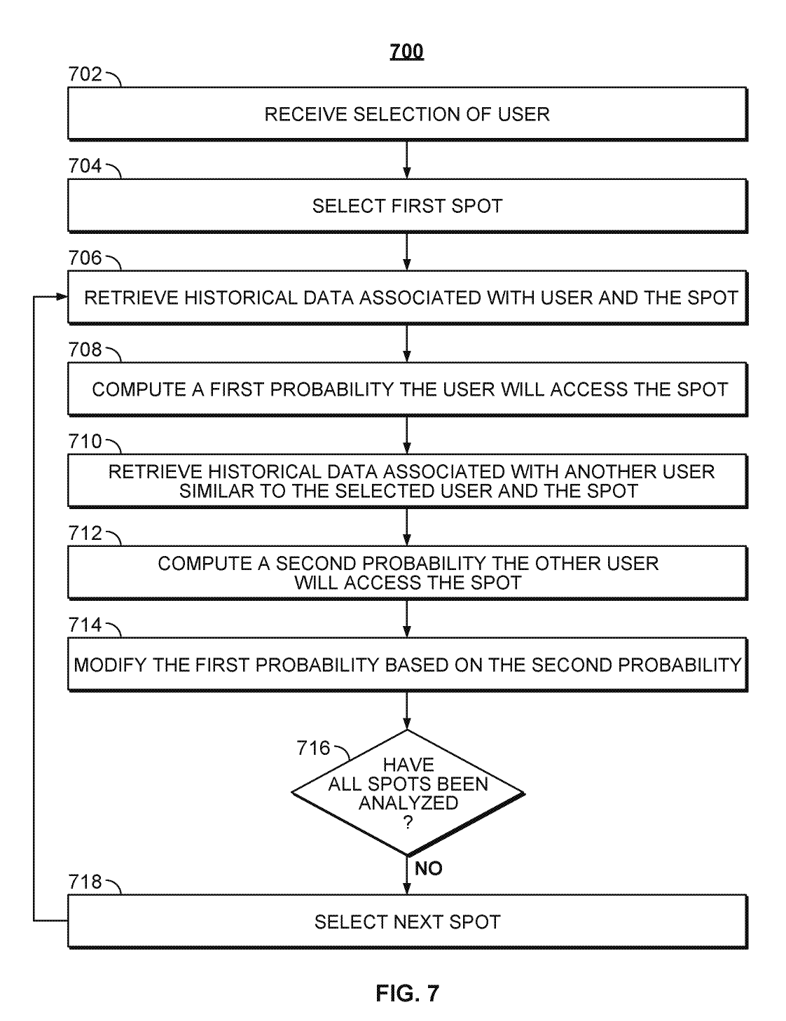

FIG. 7 shows an exemplary process 700 for computing a plurality of probabilities associated with a user, incorporating embodiments of the present disclosure. The advertisement placement circuitry may use process 700 to form an estimate of the probability a given user will access a given spot. The advertisement placement circuitry may receive user input identifying the given user who should be targeted using process 700. For example, the advertisement placement circuitry may receive user input, from user input interface 410, identifying that the given user to be used in process 700 is a female in New York between the ages 21 and 34.

Process 700 begins at block 702, when control circuitry 404 receives a selection of a user. The advertisement placement circuitry may receive the selection through user input interface 410. The selected user may represent a demographic to be targeted for the advertisement slots. For example, the advertisement placement circuitry may receive a selection of a targeted user who is male and earns less than $40,000 per year. The advertisement placement circuitry may use this targeted user to compute reach among the same demographic as the targeted user. This will allow the advertisement placement circuitry to ensure the resulting reach value is relevant to the targeted user.

Process 700 proceeds to block 704, when control circuitry 404 selects a first spot. The first spot may be one of the spots received in block 608. The advertisement placement circuitry may store the received blocks in an array using storage circuitry 408. At block 704, the advertisement placement circuitry may select a first spot from the stored array.

Process 700 proceeds to block 706, when control circuitry 404 retrieves historical data associated with the user and the spot. The historical data may be accessed from a remote server using communications network 514, or from storage network 408. The historical data may describe the historical reach for the given spot. For example, if the targeted user is a male earning less than $40,000 and the selected spot is a 8:57 pm spot on channel 8, the historical data may describe the reach in the last five weeks of the 8:57 pm spot on channel 8 for males earning less than $40,000. In some embodiments, several values of historical data may be combined using a statistical method such as computing mean, median, or mode.

Process 700 proceeds to block 708, when control circuitry 404 computes a first probability the user will access the spot. The advertisement placement circuitry may compute this probability using the historical data retrieved in block 706. For example, the advertisement placement circuitry may receive a data table listing spots in one column and a Boolean value in another column to indicate whether the corresponding spot was accessed by the user. The advertisement placement circuitry may add the Boolean values to determine how many times the user accessed the spots. If the advertisement placement circuitry retrieves historical data indicating that the targeted user accesses an 8:57 pm spot on channel 8 four out of every five nights, the advertisement placement circuitry may compute that the probability is (4 nights/5 nights=) 0.8 or 80%. The optimization circuitry may perform this computation by storing the nights that the user watched the spot in one register, storing the total number of nights in another register, and dividing the two registers.

In some embodiments, the advertisement placement circuitry may decay the value of old historical data and more heavily weight new historical data when computing the probability. For example, if the advertisement placement circuitry determines the targeted user accessed the 8:57 pm spot on channel 8 on every night last week, but on no nights this week, the advertisement placement circuitry may weigh last week's accesses using a factor of 10%. Hence, the advertisement placement circuitry may determine that the spot was accessed last week with a probability of (10%*(5 nights/5 nights))=0.1. The advertisement placement circuitry may also determine that the spot was accessed this week with a probability of (100%*(0 nights/5 nights))=0.0. The advertisement placement circuitry may add the two probability values to determine that the probability is 0.1 or 10%. The advertisement placement circuitry may also take into account the frequency, the pattern, the existence of outliers, and the randomness of the historical accesses into account when computing the probability. In some embodiments, the weight value may be calculated using other methods such as collaborative filtering or predictive machine learning algorithms to analyze the historical data.

Process 700 proceeds to block 710, when control circuitry 404 retrieves historical data associated with another user similar to the selected user and the spot. The advertisement placement circuitry may retrieve this additional historical data to fine-tune its probability calculation. For example, the selected user may be a male earning less than $40,000. However, the historical data for the targeted user may be patchy or unreliable. The advertisement placement circuitry may retrieve more reliable data for males earning between $40,000 and $45,000 to augment the previously retrieved historical data and provide better results. The advertisement placement circuitry may determine whether another user is similar to the selected user based on heuristics stored using storage circuitry 408. The heuristics may be implemented as functions that take as an input two user characteristics and return a Boolean value indicating whether the two user characteristics are similar. For example, a heuristic function may state that a user is similar to another user if the difference between their earnings is less than $5,000. Another heuristic function may state that a user is similar to another user if the difference between their ages is less than ten years.

Process 700 proceeds to block 712, when control circuitry 404 computes a second probability the other user will access the spot. The advertisement placement circuitry may compute the second probability using the historical data retrieved in block 710. The advertisement placement circuitry may compute the second probability as described in relation to block 708.

Process 700 proceeds to block 714, when control circuitry 404 modifies the first probability based on the second probability. In some embodiments, the advertisement placement circuitry may only modify the first probability if certain conditions are satisfied, such as the historical data retrieved in block 706 was unreliable or the first and second probability differ by more than a threshold amount. The advertisement placement circuitry may modify the first probability by adding a weighted version of the second probability to it. For example, the advertisement placement circuitry may modify the first probability of 0.8 using the second probability of 0.7 by weighting the difference of the two probabilities (0.7−0.8=−0.1) by 10% (0.10*−0.1=−0.01) and then adding it to the first probability to result in a modified probability of (0.8−0.01=) 0.79. The advertisement placement circuitry may then store modified probability (or the first probability, if no modified probability was created) using storage circuitry 408. The advertisement placement circuitry may also store an association between the stored probability and the spot. For example, the advertisement placement circuitry may store the information in a table, where each row includes the stored probability and the associated spot. In some embodiments, the advertisement placement circuitry may create a data structure capable of holding at least two values indicating the probability and the spot, and then store these data structures using an array, a list, or a queue in memory.

Process 700 proceeds to block 716, when control circuitry 404 determines whether all spots retrieved in block 608 have been analyzed using blocks 706-714. If the advertisement placement circuitry determines all spots have been analyzed, the advertisement placement circuitry terminates process 700. If the advertisement placement circuitry determines all spots have not been analyzed, process 700 proceeds to block 718, when control circuitry 404 selects the next spot. If all spots are stored in an array data structure, the advertisement placement circuitry may select the next element in the array. However, it is understood that the spots may be stored in any suitable data structure such as queues, stacks, trees, and the like. Once the next spot has been selected, process 700 returns to block 706.

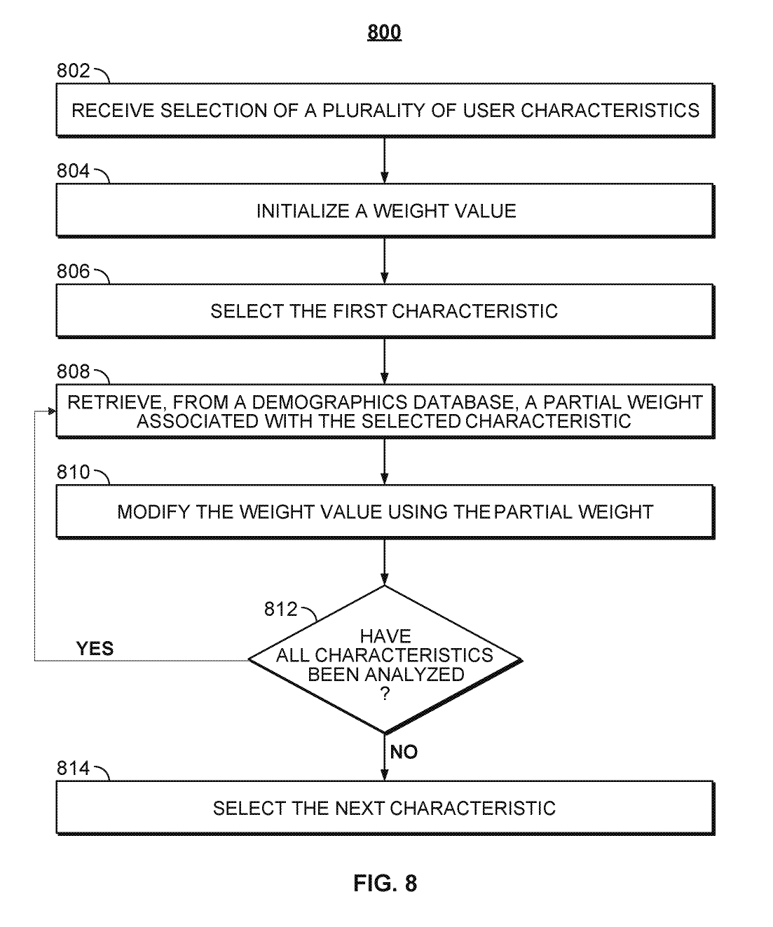

FIG. 8 shows an illustrative process 800 for computing a weight associated with a user, incorporating embodiments of the present disclosure. The advertisement placement circuitry may use process 800 to determine a weight that represents all characteristics associated with the user. In some embodiments, the weight is a ratio of a number of users in the demographics database associated with the characteristic and a total number of users in the demographics database. The user may represent a targeted user demographic, as described in relation to block 702. For example, the targeted user may have characteristics that describe a targeted demographic of females between 18 and 21 who live in California.

Process 800 begins at block 802, when control circuitry 404 receives a selection of a plurality of user characteristics. For example, the advertisement placement circuitry may receive, from user input interface 410, input that indicates the targeted user's characteristics are “female,” “between 18 and 21,” and “California.”

Process 800 proceeds to block 804, when control circuitry 404 initializes a weight value. The advertisement placement circuitry may initialize the weight value to a preset value stored using storage circuitry 408. For example, the advertisement placement circuitry may initialize the weight value to 1.

Process 800 proceeds to block 806, when control circuitry 404 selects the first characteristic. For example, if the advertisement placement circuitry received the characteristics “female,” “between 18 and 21,” and “California,” the advertisement placement circuitry may select the first characteristic “female.”

Process 800 proceeds to block 808, when control circuitry 404 retrieves, from a demographics database, a partial weight associated with the selected characteristic. The demographics database may be stored on a remote server and accessed through communications network 514, or stored locally using storage circuitry 408. The demographics database may store information indicating what percentage of the population has certain characteristics. For example, the advertisement placement circuitry may transmit the characteristic “female” to the demographics database and receive the partial weight 0.5. This partial weight indicates about 0.5 of the total population has the characteristic “female.”

In some embodiments, the partial weight may be computed using only a subset of the general population, based on the targeted demographic. For example, the advertisement placement circuitry may receive user input that the characteristics of the targeted demographic are “female,” “between 18 and 21,” and “California.” The advertisement placement circuitry may determine that the weight for females in the general world population is 0.5, but that the weight for females in California is 0.4. Since the targeted demographic includes the characteristic California, the advertisement placement circuitry may retrieve the partial weight 0.4.

Process 800 proceeds to block 810, when control circuitry 404 modifies the weight value using the partial weight. In some embodiments, the modification may comprise multiplying the initial weight value by the partial weight value. For example, if the initial weight value was 1 and the partial weight value was 0.5, the advertisement placement circuitry may multiply the two values to result in a modified weight value of 0.5.

Process 800 proceeds to block 812, when control circuitry 404 determines whether all characteristics received in block 802 have been analyzed using blocks 806-810. In some embodiments, the advertisement placement circuitry may store all characteristics as elements in an array, and test whether the last element in the array has been reached. If the advertisement placement circuitry determines all characteristics have been analyzed, the advertisement placement circuitry stores the final weight value using storage circuitry 408 and terminates process 800. If the advertisement placement circuitry determines all characteristics have not been analyzed, process 800 proceeds to block 814, when control circuitry 404 selects the next characteristic. Process 800 then repeats from block 808.

FIG. 9 shows an illustrative process 900 for computing reach values using the probability values computed using process 700 and the weight values computed using process 800, incorporating embodiments of the present disclosure. The advertisement placement circuitry may perform process 900 to directly calculate reach instead of estimating reach by calculating other quantities such as the number of impressions that measure non-unique accesses of a spot. The advertisement placement circuitry may perform process 900 several times until an optimal value of reach is calculated.

Process 900 begins at block 902, when control circuitry 404 creates sets of values to be tested. The advertisement placement circuitry may create these values using a random number generator and splitting the results into different sets. In some embodiments, the advertisement placement circuitry may create these values based on rules received from a user of the advertisement placement circuitry. For example, if the advertisement placement circuitry received a rule that no slots after 11:00 pm should be considered, then the advertisement placement circuitry may generate in each set values of “0” associated with slots after 11:00 pm. Other rules may include restrictions on channels that should be considered, restrictions on how many different channels should be considered, or restrictions on how many advertisements should be placed in a single media asset. The advertisement placement circuitry may describe each rule as a function with a Boolean output. For example, a rule function to determine whether a slot is after 11:00 pm may compare an input time to 11:00 pm and return True if the input time is greater than 11:00 pm, and False otherwise.

Process 900 proceeds to block 904, when control circuitry 404 initializes a maximum reach value. The advertisement placement circuitry may initialize the maximum reach value based on preset information stored using storage circuitry 408. For example, the advertisement placement circuitry may initialize the maximum reach value to be 0. In some embodiments, the advertisement placement circuitry may initialize the maximum reach value to be a non-zero number received using user input interface 410.

Process 900 proceeds to block 906, when control circuitry 404 selects the first set. The advertisement placement circuitry may select a first set of the sets of values generated in block 902.

Process 900 proceeds to block 908, when control circuitry 404 computes a reach value using the selected set of values. The advertisement placement circuitry may perform this computation using the probabilities computed in process 700. Each probability of user i accessing a spot t may be represented as:
pᵢₜ
   The set of values may include a different n value for each spot t. The advertisement placement circuitry may perform this computation using weight values computed in process 800. Each weight value, representing how many users in a population are represented by user i, may be represented as:
wᵢ

The reach value for all users represented by the user i accessing spots from a media plan M and using values of n from the set of values is:

$$R = {w}_{i} [ 1 - {\prod }_{t ∈ M}^{ } {( 1 - {p}_{it} )}^{n} ]$$

Since the values of n vary and can be any value, reach is calculated using a non-linear function. In some embodiments, the advertisement placement circuitry may compute the reach for multiple targeted users in a sample S at the same time:

$$R = {\sum }_{i ∈ S}^{ } {w}_{i} [ 1 - {\prod }_{t ∈ M}^{ } {( 1 - {p}_{it} )}^{n} ]$$

In these equations, R is the predicted reach, which describes the number of unique users who will be exposed to the chosen spots.

The above-described reach computations may be performed in a distributed and parallelized manner, such that each product for values of M or sum for values of S is calculated separately. These calculations may be performed on a floating-point unit or another type of arithmetic logic unit.

In some embodiments, the advertisement placement circuitry may account for various rules when computing reach. These rules may be received from a user of the advertisement placement circuitry through user input interface 410. The value of n for a certain spot t may be fixed to account for the rules. If a set includes values of n that do not conform to the values required by the rules, the resulting reach value may be deleted. For example, the advertisement placement circuitry may receive a rule that no advertisements should be placed in spots during “Show A.” To account for this, the advertisement placement circuitry may impose a condition that all n values associated with probabilities for “Show A” should be zero. If the advertisement placement circuitry computes a reach value using n values that do not conform to the rule, the resulting reach value may be deleted, and process 900 may proceed to block 916.

Process 900 proceeds to block 910, when control circuitry 404 determines whether the reach value computed in block 908 is less than or equal to a threshold reach value. The advertisement placement circuitry may have previously received the threshold reach value from a user of the advertisement placement circuitry through user input interface 410, and stored it using storage circuitry 408. For example, the advertisement placement circuitry may evaluate the following equation:

$$R = {\sum }_{i ∈ S}^{ } {w}_{i} [ 1 - {\prod }_{t ∈ M}^{ } {( 1 - {p}_{it} )}^{n} ] \leq {R}_{0}$$

wherein R₀ is the threshold reach value. If the advertisement placement circuitry determines that the reach value is less than or equal to the threshold value, process 900 proceeds to block 916. Otherwise, process 900 proceeds to block 912.

Process 900 proceeds to block 912, when control circuitry 404 determines whether the reach value is more than or equal to the maximum reach value computed in block 904 or block 914. If the advertisement placement circuitry determines that the reach value is more than or equal to the maximum reach value, process 900 proceeds to block 914. Otherwise, process 900 proceeds to block 916.

Process 900 proceeds to block 914, when control circuitry 404 sets the maximum reach value to equal the currently computed reach value. The advertisement placement circuitry may perform this block to ensure the maximum reach value is always updated to equal the highest reach value computed so far in process 900. The advertisement placement circuitry may store the current set of values and the modified reach value using storage circuitry 408. In some embodiments, the advertisement placement circuitry may log every reach value computed in a trials database to enable data analysis at a later time. The advertisement placement circuitry may store log information in the trials database such that each reach value is associated with the set of values n that was used to compute it.

Process 900 proceeds to block 916, when control circuitry 408 determines whether all sets in the sets of values have been analyzed. If the advertisement placement circuitry determines all sets have been analyzed, the advertisement placement circuitry terminates process 900. Otherwise, process 900 proceeds to block 918, when control circuitry 408 selects the next set of the sets. Process 900 then returns to block 908.

In some embodiments, the advertisement placement circuitry selects a random set of the sets instead of the next set in block 918. In some embodiments, the advertisement placement circuitry selects random values of n and adds them to the selected set. This allows the advertisement placement circuitry to test random points across the reach graph 100 to determine the general shape of the graph. For example, the advertisement placement circuitry may only be able to determine local maximum point 106 using a first plurality of sets, but may be able to identify global maximum point 110 by using a randomly selected set. The advertisement placement circuitry may hence take advantage of computing random values to better optimize reach values on reach curve 100.

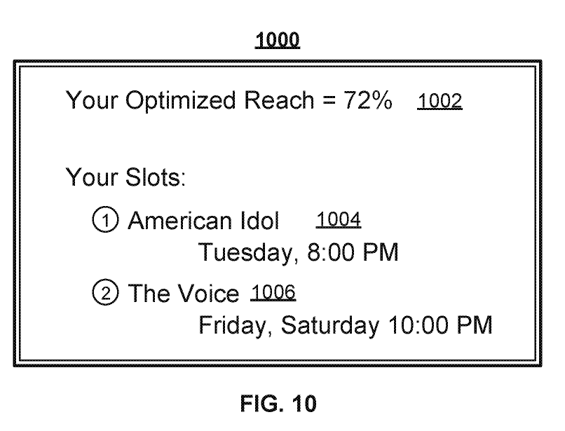

FIG. 10 shows an exemplary output screen 1000 for displaying results of the advertisement placement circuitry to a user of the advertisement placement circuitry, incorporating embodiments of the present disclosure. Output screen 1000 may be generated for display by control circuitry 404 using display 412. In some embodiments, output screen 1000 may be accompanied by sounds from speakers 414. The information shown in output screen 1000 is exemplary, and any other combination of information and results, as described in this disclosure, may be displayed without departing from the scope of this disclosure.

Output screen 1000 includes reach indicator 1002 that states an optimized reach value. This optimized reach value may be the maximum reach value computed using process 900. Output screen 1000 also includes slot identifiers 1004 and 1006. Slot identifiers 1004 and 1006 may indicate to the user which slots the user should purchase and put advertisements on to achieve the displayed reach value. In some embodiments, the advertisement placement circuitry may sort slot identifiers 1004 and 1006 based on their respective contributions to the overall reach value 1002, so that media assets with greater contributions are displayed before those with lesser contributions. In some embodiments, the advertisement placement circuitry may sort and display slot identifiers 1004 and 1006 so the more affordable slot identifiers are displayed higher on the list. The advertisement placement circuitry may also e-mail this information to the user or print it out for the user instead of, or in addition to, displaying output screen 1000.

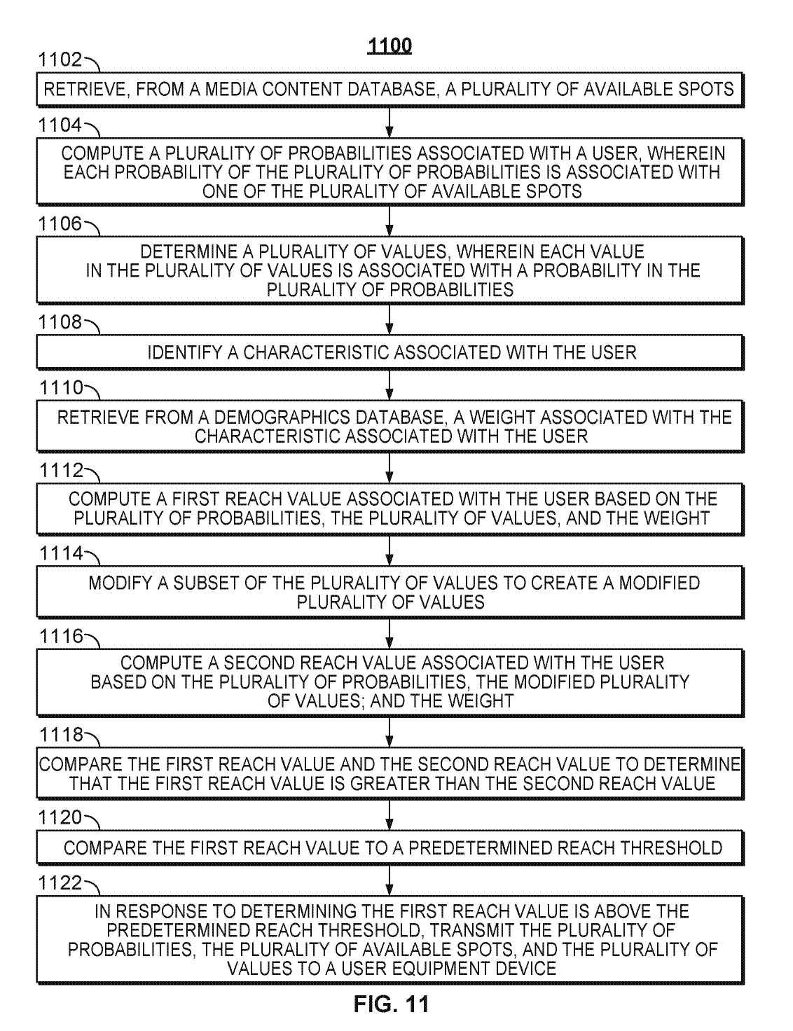

FIG. 11 shows an exemplary process 1100 for performing non-linear reach optimization, incorporating embodiments of the present disclosure. Process 1100 begins at block 1102, when control circuitry 404 retrieves, from a media content database, a plurality of available spots. The advertisement placement circuitry may perform this block as described in relation to FIG. 6. For example, the advertisement placement circuitry may retrieve the following spots in a data structure such as an array or a dictionary: {(Channel 8, 5:57 pm), (Channel 11, 2:31 pm)}. Process 1100 proceeds to block 1104, when control circuitry 404 computes a plurality of probabilities associated with a user, wherein each probability of the plurality of probabilities is associated with one of the plurality of available spots. The advertisement placement circuitry may compute probabilities as described in relation to FIG. 7. For example, the advertisement placement circuitry may compute probabilities {0.45, 0.67} for the retrieved available spots {(Channel 8, 5:57 pm), (Channel 11, 2:31 pm)}.

Process 1100 proceeds to block 1106, control circuitry 404 determines a plurality of values, wherein each value in the plurality of values is associated with a probability in the plurality of probabilities. The advertisement placement circuitry may determine a set of values n, wherein each value corresponds to a probability pᵢₜ, as described in relation to FIG. 9.

Process 1100 proceeds to block 1108, when control circuitry 404 identifies a characteristic associated with the user. This may be done as described in relation to blocks 806 and 814. For example, the advertisement placement circuitry may determine that one characteristic of the targeted user is “earns less than $40,000.” Although one characteristic is discussed here, it is understood that a targeted user can have any number of characteristics. Process 1100 proceeds to 1110, when control circuitry 404 retrieves, from a demographics database, a weight associated with the characteristic associated with the user. The advertisement placement circuitry may perform this block as discussed in relation to FIG. 8. For example, the advertisement placement circuitry may retrieve the weight 0.3 with the characteristic “earns less than $40,000.”

Process 1100 proceeds to block 1112, when control circuitry 404 computes a first reach value associated with the user based on the plurality of probabilities, the plurality of values, and the weight. The advertisement placement circuitry may perform this block as described in relation to FIG. 9. For example, the advertisement placement circuitry may compute a first reach value of 0.60.

Process 1100 proceeds to block 1114, when control circuitry 404 modifies a subset of the plurality of values to create a modified plurality of values. The advertisement placement circuitry may modify the values of n used in block 1112 by selecting a new set of values as described in relation to FIG. 9. In some embodiments, the advertisement placement circuitry may edit a predetermined number of the current set of values instead of selecting a new set of values. Process 1100 proceeds to block 1116, when control circuitry 404 computes a second reach value associated with the user based on the plurality of probabilities, the modified plurality of values from block 1114, and the weight. The advertisement placement circuitry may compute the second reach value as described in relation to FIG. 9. For example, the advertisement placement circuitry may compute that the second reach value is 0.55. The advertisement placement circuitry may compute a first and second reach value to be able to compare them and pick out the optimal reach value for the user. Although only two reach values are discussed here, it is understood that any number of reach values may be computed and compared. For example, several reach values can be computed using the processes described in relation to FIG. 9.

Process 1100 proceeds to block 1118, when control circuitry 404 compares the first reach value and the second reach value to determine that the first reach value is greater than the second reach value. For example, the advertisement placement circuitry may compare the first reach value of 0.60 and the second reach value of 0.55 to determine that the first reach value is greater than the second reach value. In response to this determination, the advertisement placement circuitry may discard the second reach value by removing it from storage or storing it in a different location than the first reach value.

Process 1100 proceeds to block 1120, when control circuitry 404 compares the first reach value to a predetermined reach threshold. The advertisement placement circuitry may use a predetermined reach threshold from storage circuitry 408, such as R₀ from block 910, and compare it to the first reach value. Process 1100 proceeds to block 1122, when control circuitry 404, in response to determining that the first reach value is above the predetermined reach threshold at block 1120, transmits the plurality of probabilities, the plurality of available spots, and the plurality of values to a user equipment device. The user equipment device may be any of user television equipment 602, user computer equipment 604, and wireless user communications device 606. The user equipment device may process and sort this data to generate for display information as shown in output screen 1000. In some embodiments, if a value of the plurality of values indicates that a corresponding available spot should not be selected (for example, if a value is 0 for a certain spot), the advertisement placement circuitry may not transmit that spot to the user equipment device.

In some embodiments, if multiple user demographics are being targeted, the advertisement placement circuitry may execute process 1100 twice, once for each targeted user demographic. For example, if the user demographics “male under 8” and “female under 8” are being targeted, the advertisement placement circuitry may execute process 1100 using the user demographic “male under 8” to determine a first reach value and then execute process 1100 using the user demographic “female under 8” to determine a second reach value. The advertisement placement circuitry may then combine the first and second reach values to result in an overall reach value. The two reach values may be combined using any appropriate computation, such as addition, weighted addition, or averaging.

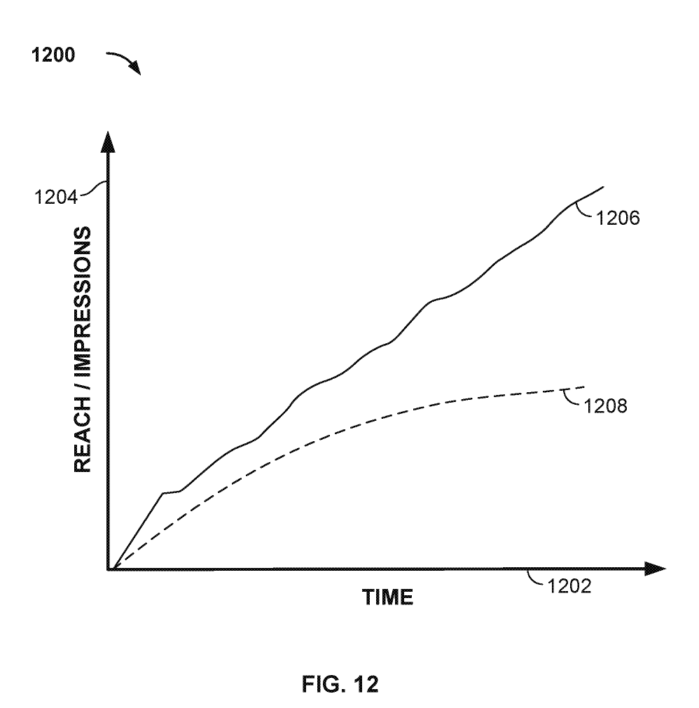

FIG. 12 shows an illustrative reach and impressions graph incorporating some embodiments of this disclosure. Graph 1200 includes a reach curve 1208 and an impressions curve 1206. Reach curve 1208 is similar to the curve shown in reach graph 100. Reach/impressions axis 1204 is similar to y-axis 104 of reach graph 100. Reach/impressions axis 1204 measures both reach for reach curve 1208 and impressions for impressions curve 1206. Reach/impressions axis 1204 may measure these curves using different scales or measurement values. A different x-axis is used in reach graph 100 and graph 1200. X-axis 102 of reach graph 100 measures a number of spots, while time axis 1202 measures the amount of time spent in an advertisement campaign by an advertisement campaign manager. Time axis 1202 may be measured in any time unit such as seconds, minutes, hours, days, weeks, months, or years. As time axis 1202 increases from left to right, the number of spots used in an advertisement campaign may increase or decrease as well. It is understood that reach/impressions axis 1204 and time axis 1202 may be swapped.

Graph 1200 shows the reach and impressions associated with an advertisement campaign. As referred to herein, an advertisement campaign may refer to a collection of advertisement spots made available to a target audience for an amount of time. An advertisement campaign may be a historical advertisement campaign or a hypothetical predictive model. The spots associated with an advertisement campaign may change during the duration of the advertisement campaign. The advertisement campaign may be managed by an advertisement campaign manager, who may use the optimization system described herein to optimize the advertisement campaign. An advertisement campaign may be optimized by increasing its reach. Reach curve 1208 and impressions curve 1206 may be measured as accumulated values from the beginning of the advertisement campaign to the end.

Impressions curve 1206 measures the number of accesses that advertisement spots in an advertisement campaign receive. Impressions curve 1206 measures the number of total accesses received, instead of measuring accesses from unique people, as reach curve 1208 does. Impressions curve 1206 may be monotonically increasing. That is, impressions curve 1206 may not decrease as time axis 1202 increases. This may be because as time goes on, the spots in the advertisement campaign may accumulate more accesses.

Reach curve 1208 measures the number of unique people who have accessed at least one spot in an advertisement campaign. Similar to impressions curve 1206, reach curve 1208 may be monotonically increasing. Reach curve 1208 may increase more slowly than impressions curve 1206 because reach curve 1208 only counts accesses received from unique people, while impressions curve 1206 counts all accesses received. As time axis 1202 increases, the number of unique people who have not yet accessed at least one spot in the advertisement campaign may decrease. Thus, the number of unique people available for growing the reach curve 1208 decreases.

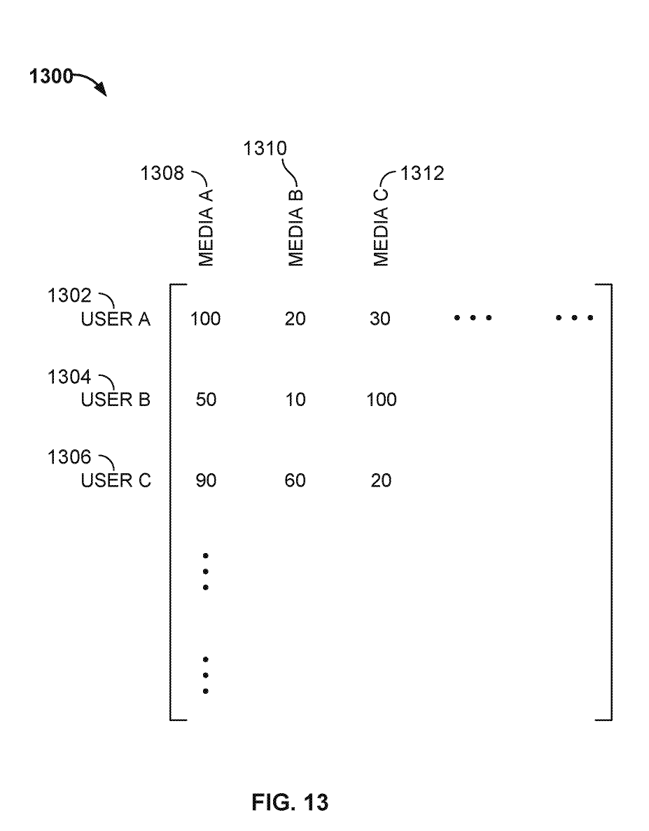

FIG. 13 shows an exemplary matrix for storing access time values associated with multiple users and multiple media sources incorporating some embodiments of this disclosure. It is understood that matrix 1300 may be of any size. That is, matrix 1300 may have any numbers of rows and columns. The number of rows in matrix 1300 may be different from the number of columns in matrix 1300. It is understood that the rows and columns in matrix 1300 may be swapped. Matrix 1300 may be associated with an advertisement campaign.

Each row in matrix 1300 is associated with a different user. Row 1302 is associated with user A, row 1304 is associated with user B, and row 1306 is associated with user C. In some embodiments, each row in matrix 1300 may represent a user who accessed a spot in an advertisement campaign. In some embodiments, some rows in matrix 1300 may represent users who did not access any spot in an advertisement campaign. In some embodiments, a separate data structure, such as a table, may store demographic information about each user in matrix 1300.

Each column in matrix 1300 is associated with a different media source. A media source may be any source of media content or data that includes advertisement spots, for example, such as media content source 516. For example, media sources may include television channels, television programs, advertisement spots, print media, radio programs, on-demand media portals, websites, newspapers, and streaming programs.

Column 1308 is associated with media source A, column 1310 is associated with media source B, and column 1312 is associated with media source C. In some embodiments, each column in matrix 1300 may represent a media source used in an advertisement campaign. A media source may be used in an advertisement campaign when the advertisement campaign includes slots of that media source. In some embodiments, some columns in matrix 1300 may represent media sources not used in an advertisement campaign. In some embodiments, a separate data structure, such as a table, may store metadata about each media source in matrix 1300.

Each value in matrix 1300 may represent an access time value. An access time value may be associated with a row and a column. An access time value may represent the amount of time a user associated with its row accessed the media source associated with its column. For example, access time value 20 is associated with row 1302 and column 1310. Access time value 20 may represent the amount of time user A associated with row 1302 accessed media source B associated with column 1310. Access time values may be measured using any time unit, such as seconds, minutes, or hours. In some embodiments, matrix 1300 may use the same time unit for all access time values. In some embodiments, matrix 1300 may use different time units for the access time values.

In some embodiments, each value in matrix 1300 may represent an access time value associated with a particular program within a media source, or a particular time period for a media source. For example, access time value 20 may represent the amount of time user A associated with row 1302 accessed media source B associated with column 1310 between 7:00 pm and 8:00 pm.

In some embodiments, each value in matrix 1300 may be a predicted access time value created using probabilities as computed in step 1104 described above. For example, access time value 20 may represent the amount of time user A associated with row 1302 will likely access media source B associated with column 1310 for.

In some embodiments, an access time value of “0” may be used to identify users and/or media sources for which information is not available. In some embodiments, access time values such as “NaN” (not a number), negative numbers, or error messages may be used to identify users and/or media sources for which information is not available. In some embodiments, the access time values may be stored in matrix 1300 using a sparse matrix structure.

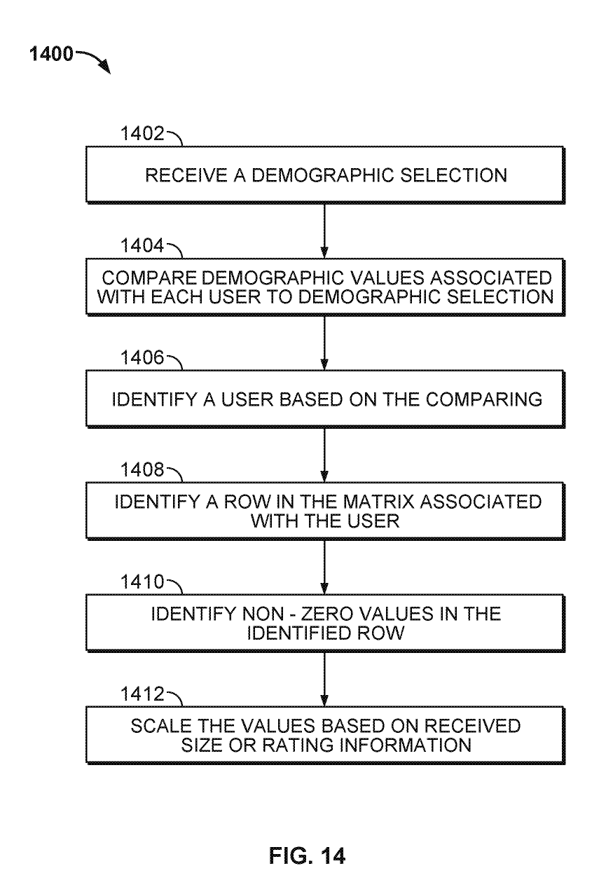

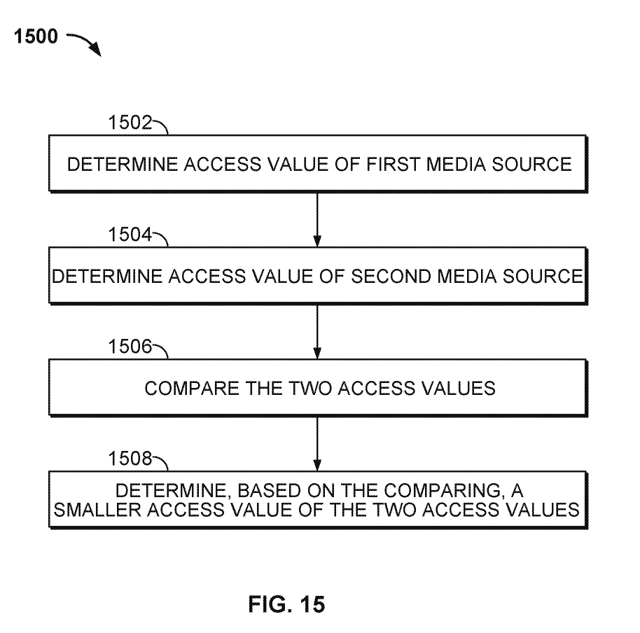

FIG. 14 shows an illustrative process 1400 for identifying access time values associated with a user incorporating some embodiments of the present disclosure. Process 1400 may be performed by the optimization system using control circuitry 404.

At step 1402, the optimization system may receive a demographic selection from user input interface 410. In some embodiments, the optimization system may receive the demographic selection from the advertisement campaign manager. The demographic selection may indicate that process 1400 should identify access time values associated with a user who fulfills the demographic selection. A demographic selection may comprise a selection of any value of a demographic characteristic, such as gender, location, or occupation. A demographic selection may comprise a selection of any range of a demographic characteristic, such as an age range or a salary range. Demographic criteria may include any other criteria for grouping people as well. In some embodiments, the received demographic selection may comprise a combination of values and ranges of demographic characteristics. For example, the optimization system may receive a demographic selection of “males, ages 25-40” from user input interface 410.

At step 1404, the optimization system may compare demographic values associated with each user to the received demographic selection using control circuitry 404. In some embodiments, each user may be a user associated with a row of matrix 1300. In some embodiments, demographic values associated with each user may be retrieved from storage circuitry 408. In some embodiments, if the received demographic selection was a single value of a demographic characteristic or a single range of a demographic characteristic, the optimization system may compare demographic values associated with each user to the received demographic selection. For example, if the received demographic selection was “males,” the demographic values associated with each user may be compared to the selection “males.” In some embodiments, if the received demographic selection was multiple values and/or ranges of demographic characteristics, the optimization system may compare demographic values associated with each user to each of the demographic characteristics in sequence. For example, if the received demographic selection was “males, ages 25-40,” the demographic values associated with each user may be first compared to the selection “males” and then to the selection “ages 25-40.” The optimization system may determine that the user fulfills the demographic selection if the user fulfills all of the multiple values and/or ranges in the demographic selection, above a specified threshold of the multiple values and/or ranges in the demographic selection, or at least one of the multiple values and/or ranges in the demographic selection.

At step 1406, the optimization system may identify a user based on the comparing of step 1404 using control circuitry 404. In some embodiments, the optimization system may compare demographic values associated with each user to the received demographic selection in step 1404 until a first user who fulfills the received demographic selection is found. Process 1400 may then proceed to step 1406, where the user who fulfilled the received demographic selection is identified. Identifying a user may comprise storing an identifier associated with the user in a cache using storage circuitry 408.

In some embodiments, the optimization system may compare demographic values associated with each user to the received demographic selection in step 1404 until all users in matrix 1300 who fulfill the received demographic selection are found. Process 1400 may then proceed to step 1406, where either all users, or any subset of all users, who fulfilled the received demographic selection are identified. In some embodiments, the optimization system may remove all rows from matrix 1300 except those associated with users who fulfill the received demographic selection.

At step 1408, the optimization system may identify a row in the matrix associated with the user using control circuitry 404. Each user may be associated with a unique identifier. For example, user A may have the identifier “A.” This identifier may have been stored in a cache using storage circuitry 408 during step 1406, and may be retrieved during the present step. The optimization system may, using control circuitry 404, identify a row in matrix 1300 also associated with the retrieved identifier. For example, the optimization system may determine that row 1302 is associated with user A and has the identifier “A,” which matches the retrieved identifier. Thus, the optimization system may identify row 1302.

At step 1410, the optimization system may identify non-zero values in the identified row using control circuitry 404. The optimization system may have identified a row during step 1408. The optimization system may retrieve access time values associated with the row using storage circuitry 408. The optimization system may compare each of the retrieved values to zero, and discard the values that equal zero. These values may indicate no data exists at that position in matrix 1300. In some embodiments, the optimization system may also discard negative values, or any values that are not numbers.

At step 1412, the optimization system may scale the values based on received size or rating information. The optimization system may receive information associated with the audience size of media sources in matrix 1300 of FIG. 13 or with the ratings of media sources in matrix 1300 from user input interface 410 or media guidance data source 518. The optimization system may also receive this information from the metadata associated with the media sources in matrix 1300. The optimization system may scale the values identified in step 1410 based on the received information. For example, column 1308 has an audience size of 10 and an access time value of 30 seconds; column 1310 has an audience size of 20 and an access time of 30 seconds. The optimization system may decide to scale the access time values based on the audience: control circuitry 404 may compute that the scaled value associated with column 1308 is 10*30=300 and the scaled value associated with column 1310 is 20*30=600. In another example, column 1308 has a rating of 5/5 stars and an access time value of 30 seconds; column 1310 has a rating of 2/5 stars and an access time of 30 seconds. The optimization system may decide to scale the access time values based on the audience: control circuitry 404 may compute that the scaled value associated with column 1308 is (5/5)*30=30 and the scaled value associated with column 1310 is (2/5)*30=12. In some embodiments, scaling may be accomplished by using other mathematical operators such as addition or logarithms instead of multiplication. In some embodiments, scaling may change access time values to more accurately reflect their importance or desirability to the advertisement campaign manager. Scaling may increase the value of access time values associated with users or media sources with targeted demographics.

FIG. 15 shows an illustrative process for determining a minimum access value from a first access time value associated with the first media source and the user and a second access time value associated with the second media source and the user incorporating some embodiments of the present disclosure. The optimization system may perform process 1500 using control circuitry 404. It is understood that process 1500 may be used to find the minimum of any number of access time values; two access time values are shown as an example only. As referred to here, “access values” refer to access time values. In some embodiments, the optimization system may perform process 1500 in parallel for different sets of access time values by executing process 1500 in parallel using information associated with different sets of access time values.

Process 1500 may be performed on the row of access time values identified in process 1400. The access time values used in process 1500 may be associated with the same user. Each access time value used in process 1500 may be associated with a different media source. The minimum access values referred to herein may also be referred to as overlap values.

At step 1502, the optimization system determines an access value of a first media system using control circuitry 404. For example, the optimization system may determine that the access value associated with user A and media source A is 100 seconds.

At step 1504, the optimization system determines an access value of a second media system using control circuitry 404. For example, the optimization system may determine that the access value associated with user A and media source B is 20 seconds. If more than two access values are being used in process 1500, step 1504 may be performed for the remaining access values as well.

At step 1506, the optimization system compares the two access values determined in steps 1502 and 1504 using control circuitry 404. For example, the optimization system may compare the access value 100 seconds determined in step 1502 and the access value 20 seconds determined in step 1504.

In some embodiments, if process 1500 is being performed with more than two access values, process 1500 may compare all the access values being used. For example, if process 1500 is being performed with three access values 20 seconds, 10 seconds, and 5 seconds, all three access values may be compared. In some embodiments, if the access values are in different units, all access values may be converted to the smallest units using control circuitry 404. For example, if a first access value is 1 minute and a second access value is 20 seconds, control circuitry 404 may determine that the smallest units are seconds, and convert the first access value to 60 seconds.

At step 1504, the optimization system determines, based on the comparing and using control circuitry 404, a smaller access value of the two access values. For example, the optimization system may determine that of access values 100 seconds and 20 seconds, the access value 20 seconds is smaller. In some embodiments, if a different number of access values is being used in process 1500, a smallest access value of all access values may be determined. For example, the optimization system may determine that of access values 20 seconds, 10 seconds, and 5 seconds, access value 5 seconds is the smallest.

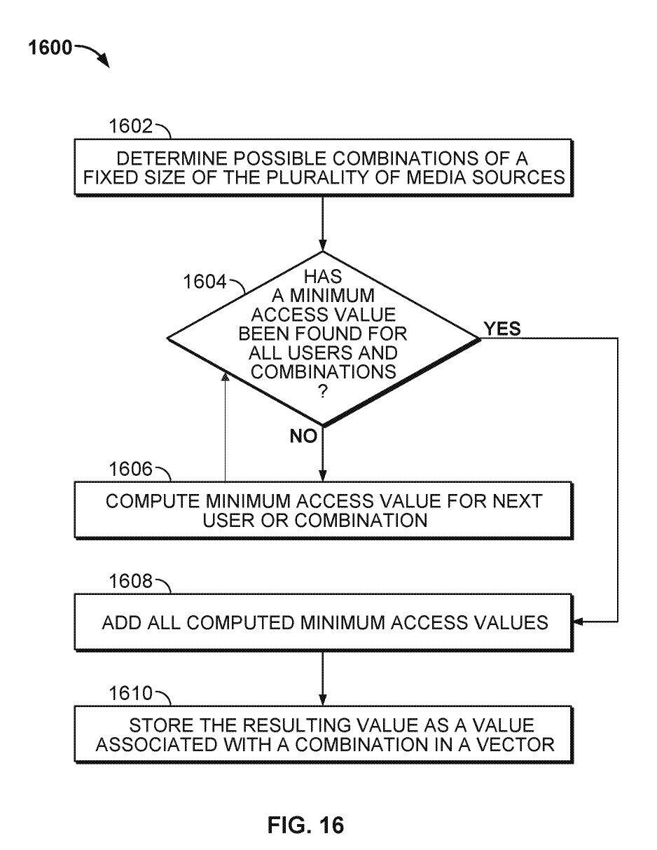

FIG. 16 shows an illustrative process for creating an overlap value associated with a pair of media sources incorporating some embodiments of the present disclosure. Process 1600 may be performed to determine an overlap value associated with a particular pair of media sources. The pair of media sources may have been accessed by a user identified in step 1406. The access values used in process 1600 may be access values identified during process 1400. The media sources may be media sources from matrix 1300 associated with the non-zero access values identified during process 1400. In some embodiments, the optimization system may compute the overlap value associated with different pairs of media sources in parallel by executing process 1600 in parallel using information associated with different pairs of media sources. Although this discussion refers to pairs, it is understood that combinations of any size of media sources may be created, such as triples, or any other n-tuples.

At step 1602, the optimization system determines possible combinations of a fixed number of the plurality of media sources using control circuitry 404. The fixed number determines the number of media sources in each combination created in this step. In some embodiments, the fixed number may be received from an advertisement campaign manager using user input interface 410. For example, optimization system may receive a fixed number two. In some embodiments, the optimization system may determine all possible combinations by combining media sources various ways to identify all unique combinations. For example, the optimization system may combine media sources A, B, and C into combinations of two to create the following unique combinations: (A, B), (B, C), and (C, A).

In some embodiments, the optimization system may receive a demographic selection using user input interface 410, as discussed in relation to step 1402. The optimization system may compare the demographic selection to metadata associated with each media source in matrix 1300. The optimization system may identify media sources that fulfill the demographic selection. This may be done in a manner analogous to that described in relation to step 1404. The optimization system may then compute combinations using only those media sources that fulfilled the demographic selection. For example, matrix 1300 may include media sources A, B, C, D, E, and F. The optimization system may receive a demographic selection of “males, ages 25-40.” The optimization system may compare this demographic selection to metadata associated with each media source to determine that media sources A, C, and F fulfill the demographic selection. The optimization system may create the following combinations of two media sources each: (A, C), (C, F), and (F, A).

In some embodiments, the optimization system may receive a demographic selection using user input interface 410, as discussed in relation to step 1402. The optimization system may compare the demographic selection to metadata associated with each user in matrix 1300. The optimization system may identify users that fulfill the demographic selection. This may be done in a manner analogous to that described in relation to step 1404. The optimization system may then compute minimum access values in step 1604 using only those users that fulfilled the demographic selection. In some embodiments, if no user selection is received, the optimization system may compute minimum access values in step 1604 for all users in matrix 1300.

At step 1604, the optimization system determines whether a minimum access value has been found for possible combinations and users determined in step 1602 using control circuitry 404. If this determination is true, process 1600 proceeds to step 1608. If this determination is false, process 1600 proceeds to step 1606.

In some embodiments, the optimization system may receive user input from user input interface 410 stating that the user only wants to compute an overlap value for a particular pair of media sources. The optimization system may determine at step 1604 whether a minimum access value has been found for the user-selected pair of media sources. For example, the optimization system may receive user input stating that the user wants to compute an overlap value for the pair of media sources (A, B). The optimization system may determine whether a minimum overlap value has been computed for pair of media sources (A, B) for all users. If this determination is true, process 1600 proceeds to step 1608. If this determination is false, process 1600 proceeds to step 1606.

At step 1606, the optimization system computes a minimum access value for the next user or combination using control circuitry 404. The optimization system may compute a minimum access value as described in relation to FIG. 15. For example, if the current combination is media sources (A, B) as accessed by user A, and the media sources are associated with access values (100 seconds, 20 seconds), the optimization system may use process 1500 to compute a minimum access value of 20 seconds. Minimum access values may be determined for combinations of any number of media sources as accessed by any user.

In some embodiments, step 1606 may be executed in parallel to compute multiple minimum access values associated with a particular pair of media sources or a particular user simultaneously. For example, the optimization system may compute multiple minimum access values associated with the pair of media sources (A, B) simultaneously, and thus compute a value of 10 seconds associated with user A and a value of 5 seconds associated with user B.

At step 1608, the optimization system adds all computed minimum access values using control circuitry 404. The optimization system may add minimum access values computed during each iteration of 1606 that was associated with a pair of media sources to create a value associated with each pair of media sources. For example, the optimization system may have computed the minimum access values associated with the combination (A, B) for users A, B, and C to be 20 seconds, 10 seconds, and 5 seconds respectively. The optimization system may use control circuitry 404 to add these values to result in 35 seconds.

In some embodiments, the addition may happen at each iteration of step 1606, so that a running total is kept. For example, the optimization system may have computed the minimum access values associated with the combination (A, B) for users A, B, and C to be 20 seconds, 10 seconds, and 5 seconds respectively. The optimization system may have computed each minimum access value in a new iteration of 1606. The optimization system may compute the running total as follows: 20 seconds during the first iteration associated with user A, 30 seconds during the second iteration associated with user B, and 35 seconds during the third iteration associated with user C.

At step 1610, the optimization system stores the resulting value as a value associated with a pair of media sources in a vector. The optimization system may store the value using storage circuitry 408. The vector may include an overlap value associated with each pair of media sources. In some embodiments, the vector may be updated or appended to each time process 1600 runs. In some embodiments, the minimum access values in the vector may be stored using different time units. In some embodiments, the minimum access values in the vector may be stored using the same time units. In some embodiments, the optimization system may store the vector using storage circuitry 408.

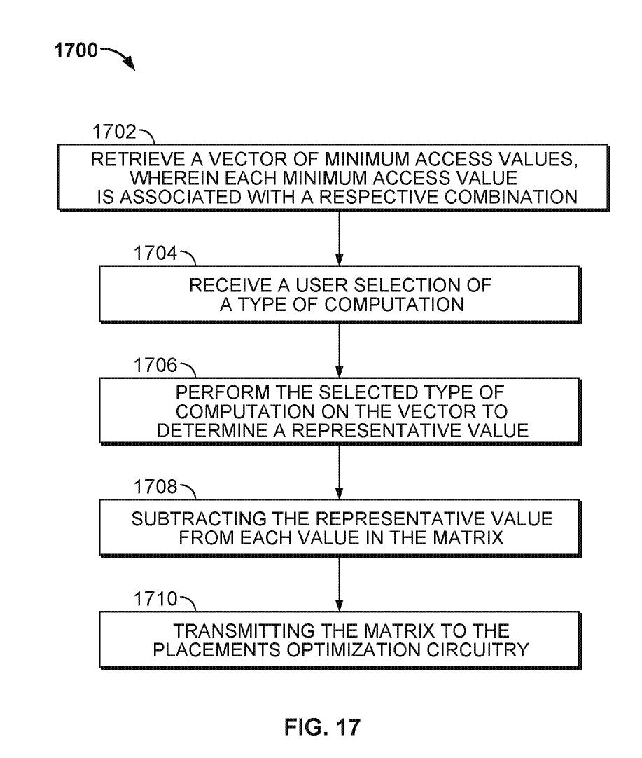

FIG. 17 shows an illustrative process for identifying a representative overlap value incorporating some embodiments of the present disclosure. The optimization system may perform process 1700 using control circuitry 404. The terms “representative value” and “representative overlap value” may be used interchangeably. Process 1700 may use the vector discussed in relation to step 1610.

At step 1702, the optimization system retrieves a vector of minimum access values, wherein each minimum access value is associated with a respective combination of media sources, such as a pair of media sources. The vector may be retrieved using storage circuitry 408. The vector may be the vector created during process 1600. For example, the vector including overlap values for pairs of media sources (A, B), (B, C), and (C, A) may be [20 seconds, 10 seconds, 20 seconds].

At step 1704, the optimization system receives a user selection of a type of computation using user input interface 410. The type of computation may be a statistical computation used for selecting a representative value. For example, the type of computation may be mean, median, or mode. In some embodiments, the median may be used as the default statistical computation because it removes some skew in data sets.

At step 1706, the optimization system performs the selected type of computation on the vector to determine a representative value. For example, the optimization system may have received a user selection of the “mode” computation in step 1704. The optimization system may compute the mode of the vector [20 seconds, 10 seconds, 20 seconds] to be 20 seconds.

In some embodiments, the optimization system may remove outlying values from the vector before performing the selected type of computation. Any number of outlying values may be removed. The outlying values may be smaller or larger than the general range of the vector data. For example, the optimization system may remove outliers from the vector [20 seconds, 10 seconds, 5 seconds, 10 seconds, 20 seconds, 150 seconds] to result in the vector [20 seconds, 10 seconds, 5 seconds, 10 seconds, 20 seconds] by removing the outlier 150 seconds. The optimization system may then perform the selected type of computation on this vector.

At step 1708, the optimization system subtracts the representative value from each value in the matrix using control circuitry 404. The optimization system may retrieve a matrix similar to matrix 1300 using storage circuitry 408. For example, the optimization system may compute the representative value to be 20 seconds. The optimization system may retrieve the below matrix using storage circuitry 408, wherein the matrix is organized as described in relation to matrix 1300. The below matrix represents access time values in seconds.

$$[ \begin{matrix}100 & 20 & 30 \\ 50 & 10 & 100 \\ 90 & 60 & 20\end{matrix} ]$$

The optimization system may subtract the representative value 20 seconds from each access time value in the matrix to result in the below matrix.

$$[ \begin{matrix}80 & 0 & 10 \\ 30 & 0 & 80 \\ 70 & 40 & 0\end{matrix} ]$$

Any subtraction that results in a value below zero may be represented as zero in the resulting matrix. This resulting matrix may represent the access time values without duplication between media sources. The resulting matrix may be a better proxy for reach values than the initial access time values.

At step 1710, the optimization system transmits the matrix to the advertisement placement circuitry using control circuitry 404. The advertisement placement circuitry may use the resulting matrix that includes access time values without duplication to select a plurality of advertisement spots to be used in an advertisement campaign. The advertisement placement circuitry may identify a set of advertisement spots that maximize reach for the advertisement campaign. In some embodiments, the advertisement placement circuitry may identify a set of spots that maximize reach while minimizing the required budget of the advertisement campaign, taking into account the price value of each advertisement slot. Advertisement placement circuitry is described in detail in previously filed U.S. Provisional Patent Application No. 62/180,934, filed Jun. 17, 2015, U.S. patent application Ser. No. 14/815,635, filed Jul. 31, 2015, Ser. No. 14/943,365, filed Nov. 17, 2015, and Ser. No. 15/162,950, filed May 24, 2016, all of which are incorporated by reference herein in their entireties.

In some embodiments, the advertisement placement circuitry described in relation to FIGS. 6-11 may use the resulting matrix to compute probability data. In some embodiments, the advertisement placement circuitry may retrieve the resulting matrix as historical data in block 706. In some embodiments, the advertisement placement circuitry may retrieve access time values for user A from the resulting matrix to be [80, 0, 10]. The advertisement placement circuitry may determine the probability of the user viewing any of the media sources in the matrix by dividing each value by the total access time value. For example, the advertisement placement circuitry may compute the probability of user A viewing any of the media sources to be [80/(80+0+10), 0/(80+0+10), 10/(80+0+10)]=[0.88, 0, 0.11]. The advertisement placement circuitry may use these probability values to compute reach as discussed above.

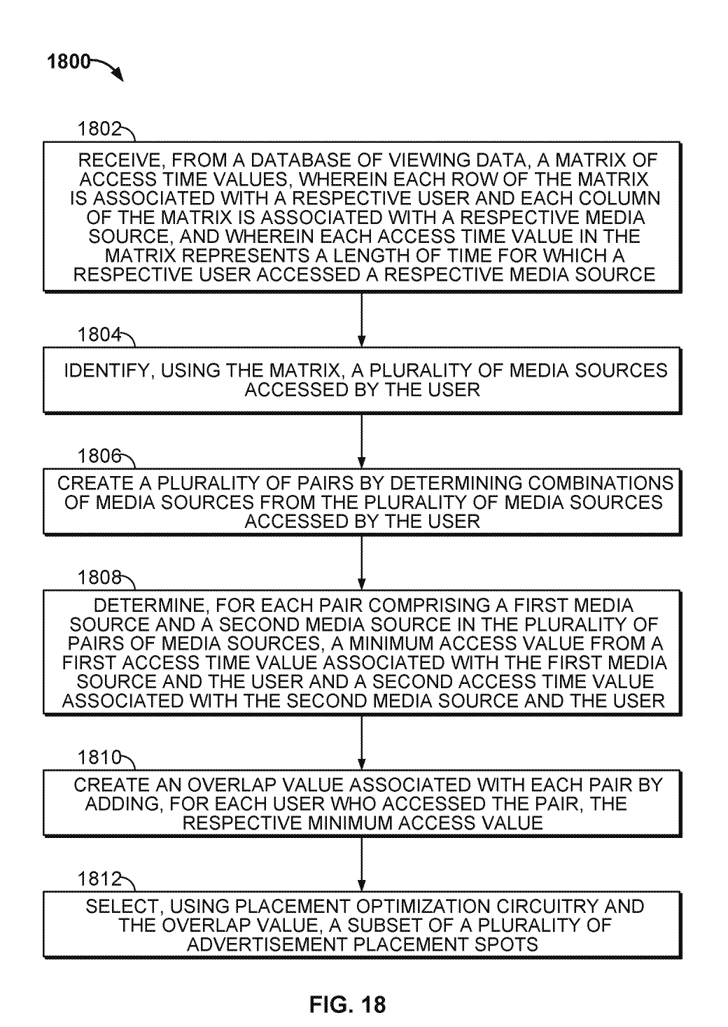

FIG. 18 shows an illustrative process for determining advertisement placements incorporating embodiments of the present disclosure. Process 1800 may be performed by the optimization system using control circuitry 404.

At step 1802, the optimization system receives, from a database of viewing data, a matrix of access time values, wherein each row of the matrix is associated with a respective user and each column of the matrix is associated with a respective media source, and wherein each access time value in the matrix represents a length of time for which a respective user accessed a respective media source. The optimization system may receive the matrix by retrieving it using storage circuitry 408, or by receiving it from a remote source such as media guidance data source 518 through communications network 514. In some embodiments, the optimization system may periodically receive the matrix. In some embodiments, the matrix may be similar to matrix 1300.

At step 1804, the optimization system identifies, using control circuitry 404 and the matrix received in step 1802, a plurality of media sources accessed by a user. The optimization system may do this as discussed in relation to FIG. 14. For example, the optimization system may determine user A accessed media source A for 10 seconds, media source B for 20 seconds, and media source C for 30 seconds.

At step 1806, the optimization system creates a plurality of pairs by determining combinations of media sources from the plurality of media sources accessed by the user using control circuitry 404. The optimization system may do this as discussed in relation to step 1602. For example, the optimization system may determine user A accessed media sources A, B, and C. The optimization system may create the pairs by determining the combinations (A, B), (B, C), and (C, A). In some embodiments, the optimization system may determine combinations of other numbers of media sources, such as triples or any other n-tuples.

In some embodiments, the optimization system may determine combinations based on a demographic selection provided by an advertisement campaign manager. For example, if the optimization system received a selection of the demographic “ages 25-40” from the advertisement campaign manager, the optimization system may use the metadata associated with each media source to identify that only media sources A, B, and F of media sources A, B, C, D, E, and F are associated with the selected demographic. The optimization system may then create pairs from the identified media sources by determining the combinations (A, B), (B, F), and (F, A).

At step 1808, the optimization system determines, for each pair comprising a first media source and a second media source in the plurality of pairs of media sources, a minimum access value from a first access time value associated with the first media source and the user and a second access time value associated with the second media source and the user. The optimization system may make this determination using control circuitry 404 and process 1500. For example, the optimization system may determine that the minimum access value associated with media sources A and B with access times 10 seconds and 20 seconds is 10 seconds.

At step 1810, the optimization system creates an overlap value associated with each pair by adding, for each user who accessed the pair, the respective minimum access value. The optimization system may do this using control circuitry 404 and process 1600. For example, the optimization system may have determined minimum access values 10 seconds, 5 seconds, and 20 seconds associated with users A, B, and C who accessed the pair of media sources (A, B). The optimization system may use control circuitry 404 to add these minimum access values to create the overlap value 35 seconds.

At step 1812, the optimization system selects, using advertisement placement circuitry and the overlap value, a subset of a plurality of advertisement placement spots. The optimization system may do this using control circuitry 404 and process 1700. The advertisement placement circuitry may select the subset of a plurality of advertisement placement spots to maximize the reach of the advertisement campaign incorporating the subset. The advertisement placement circuitry may do this as described in relation to FIGS. 6-11.

In some embodiments, the optimization system may compute a performance indicator for the plurality of advertisement placement spots. For example, the optimization system may compute, using control circuitry 404, a target index (also referred to as a core demographic index) that measures the concentration of advertisement slots in the targeted demographic of media sources and/or users. In another example, the optimization system may compute, using control circuitry 404, a target rating point and/or gross rating point. A gross rating point is a measure of the size of an advertising campaign, and a target rating point is a measure of the size of an advertising campaign within a target audience.

It should be noted that any processes, or any step thereof, could be performed on, or provided by, the optimization system on any of the devices shown in FIGS. 4-5. For example, any processes may be executed by processing circuitry 404 (FIG. 4) as instructed by processing circuitry implemented on user equipment 502, 504, and/or 506 (FIG. 5) in order to provide information to a user. In addition, one or more steps of any process may be incorporated into or combined with one or more steps of any other process or embodiment. “Blocks” and “steps” are referred to interchangeably in this disclosure.

It is contemplated that the steps or descriptions of the above figures may be used with any other embodiment of this disclosure. In addition, the steps and descriptions described in relation to the above figures may be done in alternative orders or in parallel to further the purposes of this disclosure. For example, each of these steps may be performed in any order or in parallel or substantially simultaneously to reduce lag or increase the speed of the system or method.

The processes discussed above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be exemplary and not limiting. Only the claims that follow are meant to set bounds as to what the present disclosure includes. Furthermore, it should be noted that the features and limitations described in any one embodiment may be applied to any other embodiment herein, and flowcharts or examples relating to one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for determining advertisement placements, the method comprising:
receiving, from a database of viewing data, a matrix of access time values, wherein each row of the matrix is associated with a respective user and each column of the matrix is associated with a respective media source, and wherein each access time value in the matrix represents a length of time for which a respective user accessed a respective media source;
identifying, using the matrix, a plurality of media sources accessed by a user;
creating a plurality of pairs by determining combinations of media sources from the plurality of media sources accessed by the user;
determining, for each pair comprising a first media source and a second media source in the plurality of pairs of media sources, a minimum access value from a first access time value associated with the first media source and the user and a second access time value associated with the second media source and the user;
creating an overlap value associated with each pair by adding, for each user who accessed the pair, the respective minimum access value; and
selecting, using advertisement placement circuitry and the overlap value, a subset of a plurality of advertisement placement spots.

2. The method of claim 1, wherein the overlap value is the first overlap value, and further comprising:
creating a plurality of overlap values, wherein each overlap value of the plurality of overlap values is associated with a respective pair, and the plurality of overlap values comprises the first overlap value; and
selecting a representative overlap value of the plurality of overlap values.

3. The method of claim 2, wherein selecting the representative overlap value further comprises selecting a mean value, a median value, or a mode value of the plurality of overlap values.

4. The method of claim 1, wherein using the advertisement placement circuitry further comprises:
computing, based on the matrix, a probability that the user will access each media source of the plurality of media sources;
computing, using the respective probability associated with each of the plurality of media sources, a respective reach value associated with each combination of the plurality of advertisement placement spots; and
identifying the subset of the plurality of advertisement placement spots that maximize a reach value.

5. The method of claim 4, wherein computing the respective reach value associated with each combination of the plurality of advertisement placement spots further comprises:
computing a plurality of probabilities, wherein each respective probability is associated with each of the plurality of advertisement placement spots; and
computing the respective reach value associated with the user based on the plurality of probabilities and a weight associated with the user.

6. The method of claim 1, further comprising receiving a selection of a demographic category, wherein each row of the matrix is associated with a respective user associated with the demographic category.

7. The method of claim 1, further comprising computing a performance indicator for the subset of the plurality of advertisement placement spots.

8. The method of claim 1, further comprising:
receiving, from the database of viewing data, a plurality of rating values, wherein each rating value is associated with an average user rating of each of the plurality of media sources; and scaling a portion of the matrix based on the plurality of rating values by multiplying each access time value in the portion of the matrix by a respective rating value.

9. The method of claim 1, further comprising:
receiving, from the database of viewing data, a plurality of size values, wherein each size value is associated with an audience size of each of each of the plurality of media sources; and
scaling a portion of the matrix based on the plurality of size values by multiplying each access time value in the portion of the matrix by a respective size value.

10. The method of claim 1, wherein creating an overlap value associated with each pair comprises creating a first overlap value associated with a first pair in parallel with creating second overlap value associated with a second pair.

11. A system for determining advertisement placements, the system comprising:
a database of viewing data configured to store a matrix of access time values, wherein each row of the matrix is associated with a respective user and each column of the matrix is associated with a respective media source, and wherein each access time value in the matrix represents a length of time for which a respective user accessed a respective media source; and
control circuitry configured to:
receive, from the database of viewing data, the matrix;
identify, using the matrix, a plurality of media sources accessed by a user;
create a plurality of pairs by determining combinations of media sources from the plurality of media sources accessed by the user;
determine, for each pair comprising a first media source and a second media source in the plurality of pairs of media sources, a minimum access value from a first access time value associated with the first media source and the user and a second access time value associated with the second media source and the user;
create an overlap value associated with each pair by adding, for each user who accessed the pair, the respective minimum access value; and
select, using advertisement placement circuitry and the overlap value, a subset of a plurality of advertisement placement spots.

12. The system of claim 11, wherein the overlap value is the first overlap value, and wherein the control circuitry is further configured to:
create a plurality of overlap values, wherein each overlap value of the plurality of overlap values is associated with a respective pair, and the plurality of overlap values comprises the first overlap value; and
select a representative overlap value of the plurality of overlap values.

13. The system of claim 12, wherein the control circuitry is configured to select the representative overlap value by selecting a mean value, a median value, or a mode value of the plurality of overlap values.

14. The system of claim 11, wherein the advertisement placement circuitry is configured to:
compute, based on the matrix, a probability that the user will access each media source of the plurality of media sources;
compute, using the respective probability associated with each of the plurality of media sources, a respective reach value associated with each combination of the plurality of advertisement placement spots; and
identify the subset of the plurality of advertisement placement spots that maximize a reach value.

15. The system of claim 14, wherein the control circuitry is configured to compute the respective reach value associated with each combination of the plurality of advertisement placement spots by:
computing a plurality of probabilities, wherein each respective probability is associated with each of the plurality of advertisement placement spots; and
computing the respective reach value associated with the user based on the plurality of probabilities and a weight associated with the user.

16. The system of claim 11, wherein the control circuitry is further configured to receive a selection of a demographic category, wherein each row of the matrix is associated with a respective user associated with the demographic category.

17. The system of claim 11, wherein the control circuitry is further configured to compute a performance indicator for the subset of the plurality of advertisement placement spots.

18. The system of claim 11, wherein the control circuitry is further configured to:
receive, from the database of viewing data, a plurality of rating values, wherein each rating value is associated with an average user rating of each of the plurality of media sources; and
scale a portion of the matrix based on the plurality of rating values by multiplying each access time value in the portion of the matrix by a respective rating value.

19. The system of claim 11, wherein the control circuitry is further configured to:
receive, from the database of viewing data, a plurality of size values, wherein each size value is associated with an audience size of each of each of the plurality of media sources; and
scale a portion of the matrix based on the plurality of size values by multiplying each access time value in the portion of the matrix by a respective size value.

20. The system of claim 11, wherein the control circuitry is configured to create an overlap value associated with each pair by creating a first overlap value associated with a first pair in parallel with creating a second overlap value associated with a second pair.

21-50. (canceled)
